(19) United States
(12) Patent Application Publication
(10) Pub. No.: US 2023/0036984 A1
(43) Pub. Date: Feb. 2, 2023

(54) SYSTEMS, DEVICES, AND METHODS FOR COMMUNICATING A WELLNESS SCORE AND/OR AN IMPROVEMENT SCORE TO AN ONLINE PLATFORM AND/OR WEBSITE AND FOR VERIFYING SAME

(71) Applicant: OutcomeMD, Inc., Los Angeles, CA (US)

(72) Inventors: Justin Saliman, Los Angeles, CA (US); Hooman Fakki, Los Angeles, CA (US); Kraig van der Klomp, Santa Clarita, CA (US)

(21) Appl. No.: 17/878,827

(22) Filed: Aug. 1, 2022

Related U.S. Application Data
(60) Provisional application No. 63/228,159, filed on Aug. 1, 2021.

(51) Int. Cl. G06Q 30/02

(52) U.S. Cl. CPC G06Q 30/0282

(57) ABSTRACT

A method and system for publishing a wellness and/or improvement score to a website (e.g., treatment provider website, ratings website, etc.) and/or online resource or platform (e.g., social media platform) may include receiving response data that responsive to a medical questionnaire from a patient device associated with a patient; preparing a post including a wellness and/or improvement score associated with the response data from the patient device. At times, user and/or provider preference data representative of preference of a user of and/or treatment provider using a client device may be used to format a post for publication that includes the wellness and/or improvement score.

### RELATED APPLICATION

This application is a NON-PROVISIONAL of, and claims priority to, U.S. patent application Ser. No. ______ entitled “SYSTEMS, DEVICES, AND METHODS FOR COMMUNICATING A WELLNESS SCORE AND/OR AN IMPROVEMENT SCORE TO AN ONLINE PLATFORM AND/OR WEBSITE” filed on 1 Aug. 2021, which is incorporated by reference in its entirety herein.

### FIELD

The present invention relates to a computer method and system for publishing wellness and/or improvement scores on a website and/or online resource.

### BACKGROUND

Medical care is undergoing unparalleled improvements largely due to unprecedented technological advancements. For example, recent implementation of electronic medical records (EMRs) has codified and along the way standardized medical treatments and diagnoses to facilitate greater efficiency in billing and patient care documentation. The primary beneficiaries of these improvements have been medical providers, such as doctors and hospitals, as well as medical insurance underwriters.

The foregoing benefits, however, have not translated to patient care. Patients have little data for assessing best providers for various treatments. Currently, there is no objective mechanism for rating quality of medical care, such as treatments, provided by medical care providers such as doctors, clinics, and hospitals. For example, a patient, today, has no way of assessing the quality of a knee replacement treatment performed by Doctor X against the quality of the same knee replacement treatment performed by Doctor Y. By virtue of being kept in the dark, the patient lacks the requisite information for making an informed best care determination. Sure, a knee replacement surgery candidate can ask friends, family, and colleagues for physician and hospital facilities recommendations and even search for and find reviews of such physicians and hospital facilities on online rating sites, but such information is merely subjective and therefore unreliable. Additionally, subjective determinations are not as effective in promoting medical care quality competition among providers as objective determinations. That is, there is little incentive for a physician or hospital to provide outstanding services relative to competing physicians and hospitals because patient reviews are not focused on any particular treatment and are general in nature. Patients are less likely to rely on a general review of a medical care provider than a particular outpatient treatment, for example. Nor is there currently a mechanism for objective cost comparison between providers to allow for comparative treatment and/or price shopping.

### SUMMARY

A method and system for publishing wellness and/or improvement scores associated with, for example, medical treatment outcomes, medical care quality, and costs is herein disclosed. In an embodiment, wellness and/or improvement scores are published on a provider website (e.g., medical doctor's website) and/or a ratings website (e.g., YELP) for viewing by, for example, prospective patients considering undergoing one or more medical treatments/procedures and for public ratings viewing.

In some embodiments, a provider device (e.g., doctor's smartphone), a provider website (e.g., doctor's and/or hospital's website), and the ratings website institute a handshake protocol to facilitate communication of the wellness and/or improvement scores to the provider device, a provider website (e.g., doctor website) and/or the ratings website. The wellness and/or improvement scores may be generated using patient responses to a medical questionnaire that may be received from, for example, a single patient device, responses to multiple medical questionnaires of the single patient device, or responses of medical questionnaires of the single patient device in addition to one or more other patient devices. The wellness and/or improvement scores may be generated based on a single treatment performed on a single patient, multiple treatments performed on a single patient, or one or more treatments performed on multiple patients. The treatment may be for physical or mental health.

In some embodiments, a server generates the wellness and/or improvement scores from responses collected from one or more patient devices. The server then publishes the wellness and/or improvement scores on the ratings website, the provider website, and/or the provider device.

In some embodiments, a provider device (e.g., doctor's smartphone) may make a request to view the provider website displaying the wellness and/or improvement scores. In response to the request, the provider website may provide the wellness and/or improvement scores to the provider device. In some embodiments, the client device may initiate verification of the wellness and/or improvement scores from the provider website to ensure the accuracy of the information provided by the provider website. For example, the provider website may embed a URL, tracking software, and/or metadata in the information supplied to the provider device to particularly identify the score that is associated with the patient of interest. The provider website may forward the request for verification from the client device to the ratings website in response to which the ratings website provides verification to the provider device directly or provides the verification to the provider website for forwarding to the provider device.

In some embodiments, a server generates and provides the wellness and/or improvement scores to the ratings website and the provider website. For example, the server may initially provide a medical questionnaire to a patient device for assessing the wellbeing and/or improvements realized by a patient associated with the patient device. Upon completion of the medical questionnaire, the patient device forwards responses the medical questionnaire (also referred to herein as “response data”) to and the server receives the response data. The server may generate wellness and/or improvement scores based on the received response data. In some embodiments, the server may receive response data from multiple medical questionnaires from the same patient device or multiple patient devices. For example, the server may generate collective wellness and/or improvement scores based on more than one treatment (e.g., knee replacement and ACL surgeries) performed on a patient or based on a similar treatment performed on multiple patients.

In some embodiments, the ratings website generates the wellness and/or improvement scores in response to receiving responses to medical questionnaire from one or more patient devices similar to the server, as described above. In this case, the ratings website may forward the wellness and/or improvement scores to the provider website, receives a request for verification from the provider website and in response sends the verification to the provider device.

In some embodiments, patients may be financially rewarded for providing answers to medical questionnaires as an incentive for providing such answers. In this case, the treatment provider (e.g., doctor, hospital) may pay a fee for receiving each questionnaire response. For example, through the server and provider website, the provider device may initiate payment to the patient device. Additionally, or alternatively, the provider device may initiate payment through the server. Additionally, or alternatively, the treatment provider may pay a third-party provider who determines the wellness and/or improvement scores and/or publishes the wellness and/or improvement scores onto an online resource each time the third party does so. The third-party provider may, for example, operate a server in communication with a patient device (from which it receives response data) and an online resource to which it publishes the wellness and/or improvement scores.

Wellness and/or improvement scores may be displayed on the provider website, the provider device, and/or the ratings website in various ways. For example, a semicircular graph may show the scores for a particular patient for a particular medical treatment performed by a particular provider. The patient's name and duration of time since the medical treatment may also be displayed. In cases where such information is displayed on a provider website, future patient candidates may view the provider website for assessment based on objective criteria. For example, the provider website may include interfaces at different points in time that show different improvement score posts provided by a ticker tape displayed on the provider webpage.

In some embodiments, the provider website may additionally or alternatively display the past costs associated with a particular medical treatment for assessment based on yet one more criterion.

Systems, devices, and methods disclosed herein may be configured and/or programmed with one or more sets of instructions, that when executed by a processor cause the processor to prepare a post including a wellness and/or improvement score associated with medical questionnaire response data received from patient device in response to receiving the response data from, for example, a patient device associated with a patient and/or that the patient may be interacting with. The post may then be in a persistent data store such as a database.

In some cases, user preference data representative of preference of a user of a client device may be received and, in response to receiving the user preference data, the post may be transmitted from the persistent data store to a provider website for publication thereon. In addition, on some occasions, the post may be transmitted from the persistent data store to a ratings website for publication thereon. In some embodiments, the wellness and/or improvement score may be generated by a server in communication with the patient device, the provider website, and/or the ratings website.

In some embodiments, a plurality of wellness and/or improvement scores may be received and used to prepare a series of posts, wherein each post of the series includes one of the plurality of wellness and/or improvement scores. The series of posts may be communicated to the provider website for publication. In some embodiments, the posts of the series may be serially displayed over time in, for example, an animated or ticker-tape-like fashion.

In some embodiments, a request to view one or more webpages of the provider website may include selection of a hyperlink associated with the provider website included in a list of search results and/or provided by a treatment facility website. For example, metadata associated with the request may be used to determine one of a selection of wellness and/or improvement scores including the wellness and/or improvement score to generate verification information used by the provider device for displaying one of the selection of wellness and/or improvement scores on the ratings webpage.

On some occasions, the method may further comprise displaying the wellness and/or improvement score on the provider website and receiving a verification request, originating from a provider device, to verify the wellness and/or improvement score on the provider website through a selection of a graphic element or icon. At times, the verification request may be communicated directly to the ratings website. Additionally, or alternatively, the post may include the wellness and/or improvement score, which may be published based on a threshold reflecting one or more user preferences of a customer of the provider device. Additionally, or alternatively, the post may include the wellness and/or improvement score, which may be published based on a threshold reflecting user preferences of a provider of the provider website.

In some embodiments, an indicator may be displayed by a webpage of the provider website for use by a viewer of the provider website to access ratings of a treatment provider. At times, different wellness and/or improvement scores may be displayed on an interface of a webpage of the provider website using a ticker tape. In some cases, the ticker tape may include a graphical representation, or icon, of a set of wellness and/or improvement scores, including the wellness and/or improvement scores of the post that have been determined for particular patients over time, which may be helpful when determining how a patient has improved (or not) over time. In some cases, the graphical representation may be in the form of a semicircle graph or a bar graph.

In some cases, the ticker tape may be one of a plurality of ticker tapes, each ticker tape associated with a plurality of wellness and/or improvement scores of a similar treatment performed on users of respective patient devices. Additionally, or alternatively, the ticker tape may be one of a plurality of ticker tapes associated with a plurality of wellness and/or improvement scores of different treatments performed on users of respective patient devices.

### BRIEF DESCRIPTION OF DRAWINGS

The present invention is illustrated by way of example, and not limitation, in the figures of the accompanying drawings in which:

FIGS. 1A, 1B, and 1C are block diagrams of exemplary systems for generating and/or presenting a medical portal interface, in accordance with some embodiments of the present invention;

FIG. 2 provides a flowchart illustrating a process for determining a threshold improvement score, in accordance with some embodiments of the present invention;

FIG. 3 provides determining a wellness and/or improvement score for a patient and determining whether the improvement score is above a pre-determined threshold, in accordance with some embodiments of the present invention;

FIG. 4 is a flowchart of an optional exemplary process for determining an adjusted improvement score for the patient, in accordance with some embodiments of the present invention;

FIGS. 5A and 5B provide a flowchart illustrating an exemplary process for preparing a message and/or a post that includes a wellness and/or an improvement score to an online platform associated with a sender of a medical questionnaire, in accordance with some embodiments of the present invention;

FIG. 6 is a flowchart illustrating a process for providing a ratings website for a treatment provider, in accordance with some embodiments of the present invention;

FIGS. 7A-7D provide screen shots of exemplary interfaces provided by webpages taken at different points in time that show different improvement score posts provided by a ticker tape displayed on the webpage, in accordance with some embodiments of the present invention;

FIGS. 8A and 8B provide screen shots of another exemplary interfaces provide by webpage taken at different points in time that show different improvement score posts provided by a ticker tape displayed on the webpage, in accordance with some embodiments of the present invention;

FIG. 9 is a screen shot of doctor information interfaces, in accordance with some embodiments of the present invention;

FIG. 10 is a diagram showing an exemplary process for communication between various components of a system to facilitate provision of an outcome verification webpage to a requester, in accordance with some embodiments of the present invention;

FIG. 11 is a diagram showing another exemplary process for communication between various components of a system to facilitate provision of an outcome verification webpage to a requester, in accordance with some embodiments of the present invention;

FIGS. 12A and 12B provide screen shots of a first set of exemplary interfaces that show outcome-based ratings for a treatment provider, in accordance with some embodiments of the present invention;

FIGS. 13A-13E provide screen shots of a second set of exemplary interfaces that show outcome-based ratings for a treatment provider, in accordance with some embodiments of the present invention, in accordance with some embodiments of the present invention;

FIG. 14A provides a time series of interfaces into which a patient may enter a comment, add a photo, and/or post a review, in accordance with some embodiments of the present invention;

FIG. 14B provides a screen shot of an exemplary bar graph ratings interface, in accordance with some embodiments of the present invention;

FIG. 14C provides a second bar graph ratings interface, in accordance with some embodiments of the present invention;

FIG. 14D provides another exemplary ratings interface that shows a bar graph of a number of patients a medical treatment provider over time in monthly increments, in accordance with some embodiments of the present invention; and

FIG. 14E provides a screen shot of a ticker tape for a webpage, in accordance with some embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### WRITTEN DESCRIPTION

The present invention provides a method and system for objective assessment of medical care, medical treatments, and medical procedures. In some embodiments, this assessment is achieved by administering scientifically verified medical questionnaires (e.g., patient recorded outcome instruments (PROs)), receiving responses to the medical questionnaires, and scoring the responses using one or more scoring metrics specifically associated with the one or more medical questionnaires administered to the patient. A result of the scoring procedure is a wellness score, which is an objective indication of an outcome of a medical intervention (or no intervention) at a particular point in time (e.g., prior to beginning treatment and/or after treatment) for the patient. In some instances, a plurality of wellness scores for a patient may be calculated over time by, for example, re-administration of the one or more questionnaires to the patient at different points in time to, for example, measure their progress toward recovery.

The medical questionnaires may be targeted to assess outcomes related to particular treatments, procedures, and/or medical care and/or procedures and/or general in nature. Exemplary medical treatments include medication, use of medical devices, physical therapy, exercise programs, psychotherapy, restricted diets and the like. Exemplary medical procedures include surgeries, application of a treatment device to an injury, and the like. Exemplary medical care is a catch-all category includes, but is not limited to, general medical care (e.g., nursing care or physician care), diagnostic tests, and other means of treating one or more medical problems and/or comorbidities a patient may have. For the sake of brevity, medical care, treatments, and procedures may be collectively referred to herein as “medical treatments” and/or “treatments.” The medical treatment may be for any type of medical diagnosis including, for example, an injury to a patient's body, such as a brain or knee injury, a disease such as diabetes or heart disease, and/or a mental condition, such as depression or anxiety.

According to the methods disclosed herein, a patient device (e.g., smart phone) associated with (i.e., used by) receives a medical questionnaire that may be specific to a diagnosis of the patient and/or a treatment he or she has undergone. The patient then answers the questions of the medical questionnaire via his or her patient device and the patient transmits data indicative of the answers to a server for scoring and evaluation to determine, for example, a wellness score and/or an improvement score for the patient. In addition to response data, the patient device may also communication information associated with the patient such as a patient identifier and/or the medical questionnaire such a medical questionnaire identifier. In some embodiments, the data communicated by the patient device to the server may be subject to one or more security policies and/or procedure (e.g., encryption and/or blockchain) to ensure sensitive healthcare and/or identifying information cannot be stolen or hacked via communication to the server. Upon receipt, the server may evaluate the received response data for completeness and may score the responses data according to the metric(s) associated with the respective medical questionnaire to determine a wellness and/or improvement score, which may be an indication of a quality of care provided to the patient and/or an outcome of the treatment for the patient. The wellness and/or improvement scores may be packaged for publication on one or more online resources such as a provider website (e.g., a doctor or hospital website), a ratings website, and/or a social media platform and then published to the respective online resource. Packaging the wellness and/or improvement scores may include, for example, generation of a graphic image file that visually/graphically depicts the wellness and/or improvement scores and/or an evaluation thereof graphically, association of one or more other online resources with the wellness and/or improvement score and/or image file via, for example, associating the wellness and/or improvement score and/or image file with one or more URLs that may, or may not be, maintained and/or managed by the server, cookies, click tracking information (e.g., a tracking script and/or a plugin), and/or association of keywords and/or metadata package including the wellness and/or improvement score and/or image file. Additionally, or alternatively, packaging the wellness and/or improvement score and/or image file may include associating one or more formatting requirements (e.g., color scheme, location on the webpage, and/or animation instructions) with the wellness and/or improvement score and/or image file. In some cases, the packing may include making the software code associated with the wellness and/or improvement score and/or image file compliant with one or more application programming interfaces (API) and/or requirements for a webpage, website (e.g., a ratings website and/or a provider's website), and/or online platform (e.g., social media platform).

Optionally, in some embodiments, a mock up, or wireframe, of a generated wellness and/or improvement score and/or image file/package may be provided to a client device (e.g., smartphone or computer) for display prior to publication as part of, for example, a pre-publication review process that may be performed by, for example, a treatment provider, a treatment facility, and/or a marketing department for the treatment provider and/or facility.

Following packaging and, when appropriate approval, the packaged wellness and/or improvement score and/or image file may then be published to the online resource for viewing by the potential patient population, or public, at large. For example, the provider website may display wellness and/or improvement scores of various patients in various forms allowing for an assessment of one or more medical treatments by patients considering undergoing similar medical treatments. The wellness and/or improvement scores may also or alternatively be published on a ratings site (e.g., YELP) for viewing by potential patients to compare medical provider treatment outcome results of various medical providers.

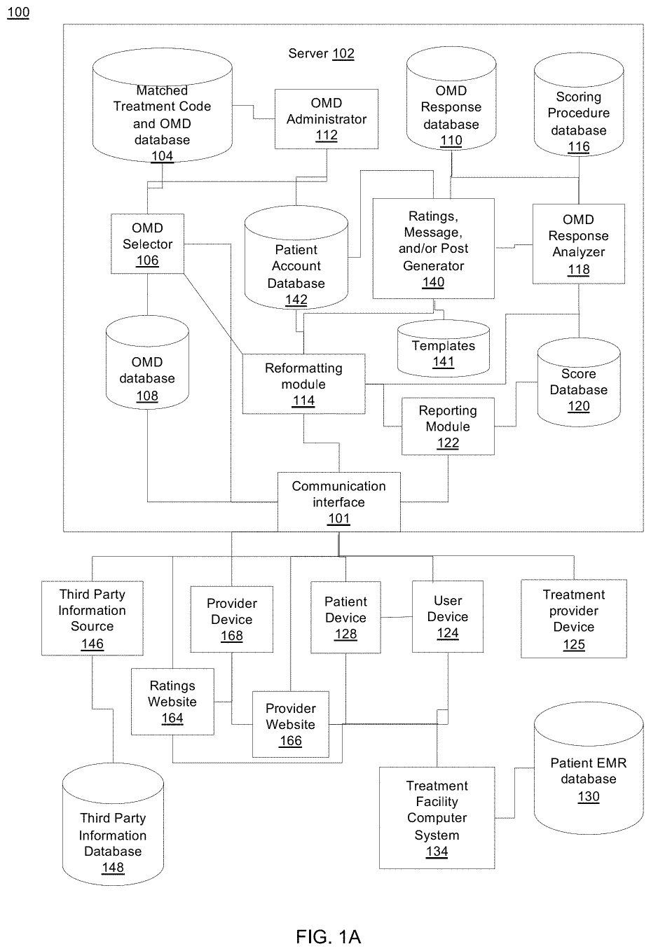

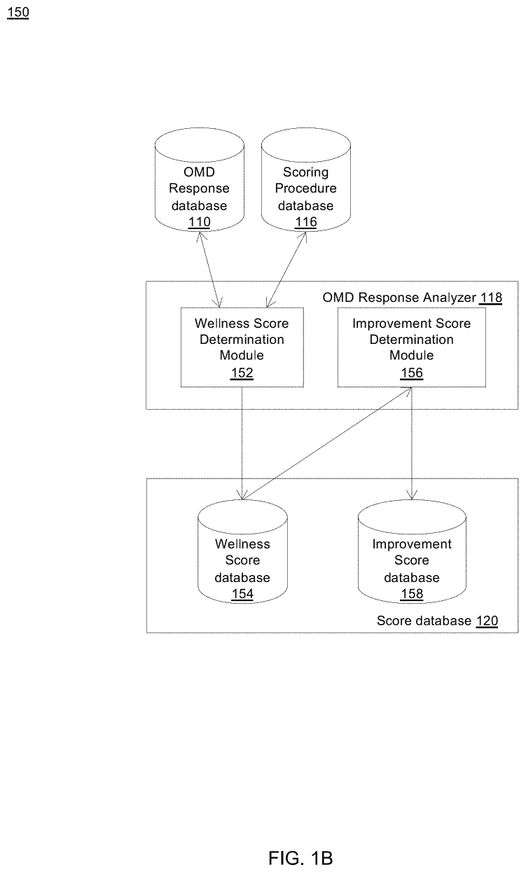

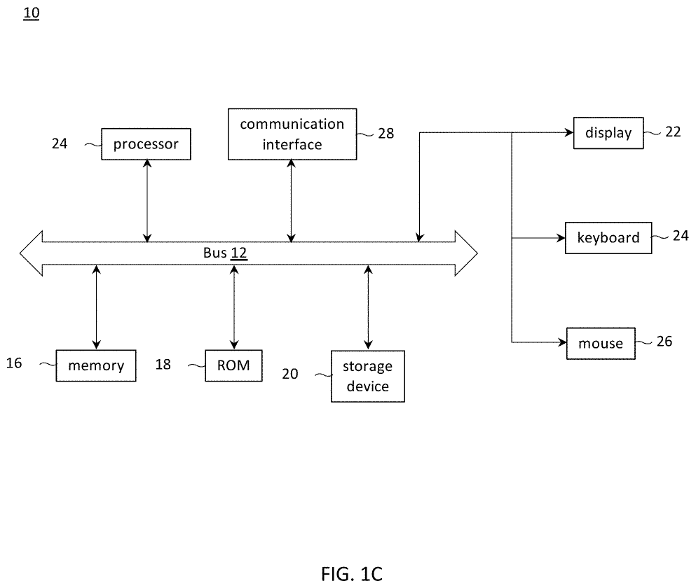

FIG. 1A provides a block diagram of an exemplary system 100 that may be used to execute one or more of the processes described herein. At a high level, system 100 includes a server 102, a patient device 128, a user device 124, a treatment provider device 125, and a treatment facility computer system 134, all directly or indirectly communicatively coupled to one another via a network like the Internet and/or a private network. Patient device 128 may be any device (e.g., a smartphone, a laptop computer, a tablet computer, a desktop computer, etc.) that enables communication between a patient and other component of system 100. Similarly, user device 124 and/or treatment provider device 125 may be any device (e.g., a smartphone, a tablet computer, a laptop computer, a desktop computer, etc.) that enables communication between a treatment provider (also referred to herein as a “user”) and other components of system 100. In some cases, treatment provider device 124 may also be a device that is enabled to perform a specific healthcare treatment and/or diagnostic task. For example, treatment provider device 125 may be a network-connected treadmill, a network connected blood pressure monitor, or a network-connected ultrasound machine. For simplicity, only one treatment provider device 125 is depicted, while it is understood that in practice there may be a plurality of treatment provider devices 125. Similarly, while only one patient device 128 is depicted, it is understood that in practice there may be a plurality of patient devices 128, one or more for each patient.

Treatment facility computer system 134 may be a computer system that is located in, and/or communicatively coupled to, a treatment facility (i.e., a computer/server that is located in a doctor's office or treatment facility). As is understood in the art, an EMR (as stored in EMR database 130) may include notes prepared by a treatment provider regarding the health of a patient, results of medical tests performed on a patient, treatments administered on a patient, etc. Further due to HIPAA regulations, medical records from treatment facility computer system 134 may be communicated to user device 124, treatment provider device 125, patient device 128, and/or server 102 using one or more security protocols that may be compliant with HIPAA requirements. It is understood that other data (i.e., not patient-specific data) may be transmitted between user device 124, patient device 128, treatment provider device 125, sever 102, and/or facility computer system 134 via a conventional communication network (e.g., the Internet, a wired network, a wireless network, a private network, a public network, routers, switches, etc.), which has not been depicted in FIG. 1A. Further, it is understood that user device 124, patient device 128, treatment provider device 125, server 102, and/or facility computer system 134 may be communicatively coupled to via a communication network (e.g., the Internet), a private network, and/or a blockchain.

In one embodiment, any one of the components of system 100 may replace any patient identifying information (e.g., patient name, social security number, birthdate, address, etc.) in medical records and/or a patient account with, for example, a binary string to form anonymized medical records containing no patient identifying information (e.g., patient name, social security number, birthdate, address, etc.). More generally, any patient identifying information in medical data (e.g., EMR, questionnaire responses provided by a patient, wellness scores computed for a patient, etc.) may be replaced with a binary string to form anonymized and/or de-identified medical data. Such anonymized medical data may be stored at, for example, server 102, treatment facility computer system 134, patient device 128, and/or user device 124, in various databases operated by server 102 (e.g., OMD response database 110, score database 120, etc.), cloud-based storage (e.g., Amazon Web services, Google Cloud platform or Microsoft Azure) (not depicted), etc. In the event the anonymized medical data is intercepted by a malicious individual (e.g., a hacker), patient privacy may still be preserved since the malicious individual will not be able to associate the anonymized medical data with any specific patient.

A mapping between respective binary strings and respective patient identifying information may be securely stored (e.g., stored in an encrypted manner) at one or more components of system 100. Such mapping may enable an electronic device (e.g., server 102, user device 124, treatment provider device 125, and/or patient device 128) to access medical data associated with a specific patient. The steps for an electronic device to access the medical data of a patient may proceed as follows. First, the electronic device may be authenticated by HIPAA compliance server (e.g., the electronic device is required to provide the proper credentials, such as a login identifier and password). Following successful authentication, the electronic device may request medical data concerning an exemplary patient, John Doe. For example, server 102 may map the patient name of “John Doe” to “patient 001010” via the mapping and/or indexing, and the medical data of patient 001010 may be retrieved from a database which stores the anonymized medical data (e.g., OMD response database 110, score database 120, etc.).

In one embodiment, the process flow for system 100 may proceed as follows. Upon server 102 receiving a request from, for example, user device 124 and/or treatment provider device 125, patient device 128, and/or server 102 may provide an outcome measurement device (OMD) to the patient, treatment provider, and/or user device 124, 125, and/or 128. An OMD may be a modality, instrument, or tool by which medical information about a patient may be collected. Exemplary OMDs include, but are not limited to, a medical questionnaire, a physical test of the patient (e.g., blood test, physical examination, or blood pressure), and a patient reported outcome (PRO) instrument. At times, an OMD may referred to as a medical questionnaire herein. In some cases, the request to administer the OMD may be triggered via the entry of a treatment code (e.g., a Current Procedural Terminology (CPT) code) or a treatment/diagnostic test name into the patient's EMR (as stored in patient EMR database 130), a treatment facility's billing software, and/or a treatment facility's scheduling software. In some instances, a request to administer and OMD may be triggered by a patient requesting receipt of an OMD via, for example, his or her wellness account and/or a request to administer an OMD may be triggered by a patient who requests to send an OMD to a friend or colleague via, for example, a link to an OMD and/or an invitation to respond to an OMD.

In some instances, when a treatment/diagnostic test name or other related information (other than a treatment/diagnostic code) is received, server 102 may interpret (using, for example, natural language analysis) the treatment/diagnostic test name so that it matches one or more treatment codes. In such cases, OMD selector 106 may determine one or more OMDs that match the treatment code via matched treatment code and OMD database 104. More generally, matched treatment code and OMD database 104 may also include matches between treatment names and OMDs, as well as diagnostic codes and OMDs when selecting OMDs for delivery to a patient device 128 and/or user device 124.

Next, OMD selector 106 may retrieve the one or more determined OMDs from OMD database 108. The retrieved OMDs may be provided to OMD administrator 112, which may administer the OMDs to the patient via, for example, patient device 128 and/or user device 124. In the instance that the retrieved OMDs are patient reported outcome (PRO) instruments, the PRO instruments may be provided to patient device 128. Completed OMDs (also called OMD responses) may be transmitted from patient device 128 (and may be received as a set of responses) and stored in OMD response database 110. More specifically, OMD responses may be stored in OMD response database 110 in an anonymized fashion. For example, OMD responses may be indexed in OMD response database 110 by a binary string, or other anonymous identifier, rather than by a patient name. Similarly, to the discussion above, if an OMD response for a specific patient is desired, the patient name may be mapped to a binary string by, for example, server 102, and the OMD response associated with that binary string may be retrieved from OMD response database 110.

OMD response analyzer 118 may analyze the OMD responses stored in OMD response database 110 to generate one or more scores (e.g., a wellness score, an improvement score, etc.). Such scores are described in more detail below with regard to FIG. 1B. Such analysis may rely upon scoring procedures stored in scoring procedure database 116. Such scoring may also rely upon other considerations and/or esoteric factors 132 stored at patient EMR database 130. In most circumstances, what may be referred to herein as “other considerations” are factors that may directly, or closely, relate to and/or have an impact on, a medical condition, diagnosis, and/or treatment. For example, it is known that smoking has an impact on a person's cardiovascular health. Thus, whether a person smokes may be an “other consideration” for a patient's treatment related to cardiovascular health. This relationship between cardiovascular health and smoking may be indexed or otherwise stored in other consideration database 132. An esoteric factor is one that is less directly related to a medical condition, diagnosis, and/or treatment but may still have an impact thereon. For example, a vegetarian diet may have an impact on a person's cardiovascular health, yet this impact may be less well understood when compared with the impact of smoking on the same patient's cardiovascular health. As such, a person's status as a vegetarian may be considered an “esoteric factor.”

The scores that are generated by OMD response analyzer 118 may be stored at score database 120. More specifically, scores may be stored in score database 120 in an anonymized fashion so as to, for example, comply with HIPAA regulations or other data security requirements/preferences. For instance, wellness scores associated with a patient may be indexed by a binary string in score database 120 rather than by a patient name. Additionally, or alternatively, information pertaining to one or more thresholds for an improvement score, adjustments to a threshold for an improvement score, and/or characteristics to associate with adjustments to a threshold for an improvement score may be stored in score database 120.

Finally, reporting module 122 may report the scores to one or more of user device 124, patient device 128, treatment provider device, 125, and/or treatment facility computer system 134. In addition to the request for a treatment, there are other events that may prompt an OMD to be administered to a patient. In one example, the scheduling of an initial appointment (e.g., a consultation) for a patient to discuss a medical condition with a healthcare professional may prompt an OMD to be administered to the patient. Administering an OMD to the patient prior to this initial appointment may be useful for establishing a baseline state of health for the patient, but the selection of the OMD may have some complexity, as no treatment code, treatment name, or diagnostic code may yet be available when the initial appointment is scheduled because, for example, a diagnosis has not been made. In many instances, all that the patient will provide is a brief description of the symptoms he/she may be experiencing (e.g., shortness of breath, fever, etc.) and/or a chief complaint. In one embodiment, such symptoms may be provided to OMD selector 106, which attempts to match the symptoms with one or more treatment codes, treatment names, or diagnostic codes and select a corresponding OMD. Such matching by OMD selector 106 may be performed using a learning machine and/or artificial intelligence. For instance, matches between, for example, symptoms and treatment codes; symptom and treatment names; and/or symptoms and diagnostic codes may be provided by a healthcare professional when treating patients, and such matches may be used to train a model that can then be used to determine treatment codes, treatment names or diagnostic codes based on, for example, a patient's symptoms and/or treatment provider notes. Upon determining a treatment code, treatment name, or a diagnostic code, OMD selector 106 may select one or more OMDs based on matches provided in matched treatment code and OMD database 104 (as described above). It is anticipated that the determination of a treatment code, treatment name or diagnostic code by OMD selector 106 may be, in some instances, an imperfect process, so a healthcare provider, or other expert, may be asked to make any necessary adjustments to the treatment code, treatment name and/or diagnostic code determination, before OMD selector 106 selects the one or more OMDs.

In the examples provided above, it was assumed that an OMD is administered to a patient via patient device 128. In other instances, a medical professional may be required to administer the OMD to the patient. For example, server 102 may notify user device 124 and/or treatment provider device 125 that one or more OMDs should be administered as part of, for example, a medical examination of a patient. In one example, if a patient has recently undergone cardiothoracic surgery, OMD administrator 112 may provide one or more OMDs to user device 124 (e.g., the Intrathoracic Gas Volume Test, Total Lung Capacity Test, Vital Capacity Test, 6 Minute Walk Test, Aortic Insufficiency Test, Mitral Regurgitation Test and/or Aortic Valve Area Test) that could, or should, be administered to the patient during an exam and/or provide one or more mechanisms to user device 124 (e.g., fillable forms) for the treatment provider to enter the OMD responses.

Server 102 may further include a patient account database 142, a rating, message, and/or post generator 140, a template database 141, and a reformatting module 114. A communications interface 101, incorporated partially or wholly into server 102 may facilitate communication between server 102 and, for example, a third-party information source 146, which in turn, may be in communication with a third-party information database 148. In some embodiments, communication interface 101 is physically externally located relative to server 102. Communication interface 101 may facilitate communication between server 102 and an external device such as third-party information source 146, patient device 128, and/or user device 124. In some embodiments, communication interface 101 may resemble communication interface 28. Exemplary information that may be received from patient account database 142 includes, but is not limited to, patient identifiers, demographic information for one or more patients, patient-entered information (e.g., adverse life events, medication/treatment compliance, answers to OMDs, supplemental treatments, etc.), treatment history, historical OMD responses, wellness scores, improvements scores, and so on.

Third-party information source 146 may be any source of information that is not the patient and/or operated by and/or directly associated with a user of user device 124 (e.g., treatment facility staff or medical professionals) and/or an entity operating server 102. Examples include pharmacies, medical treatment facilities other than medical treatment facilities coupled to treatment facility computer system 134 and/or patient EMR database 130 (e.g., laboratories, radiologists, chiropractors, physical fitness facilities, etc.), medical device retailers, and other service providers for patients such as ride-share services that may be able to provide information regarding pick-up and drop-off times for patients at a facility that may administer medical treatment. Third-party information database 148 may store information relevant to one or more patients who may, or may not, have a patient account that may be stored in patient account database 142. Exemplary information stored in third-party information database 142 includes, but is not limited to, pharmaceutical refill information (e.g., dates refills were dispensed, type and/or quantity of pharmaceuticals dispensed, etc.), purchases made at/via the third-party information source 146 (e.g., supplements, braces, durable medical goods, etc.), clinic information (e.g., when appointments were scheduled, whether patient arrived for appointment, notes from a treatment provider regarding an encounter with a patient, etc.) and so on.

Patient accounts may be associated with each individual patient under, for example, the care of a particular treatment facility. Information about a patient may be associated with and/or stored along with patient account information. Information about a patient may come from a plurality of sources including, but not limited to, the patient, a treatment provider, a user of a server providing access to a patient account, and a third-party (e.g., an insurance company, a treatment provider not associated with the treatment facility, and/or a pharmacy).

Patient accounts may be generated at/by server 102 responsively to instructions from the patient (as provided via, for example, patient device 128) and/or responsively to a user like a treatment facility administrator or medical treatment provider providing instructions via, for example, user device 124.

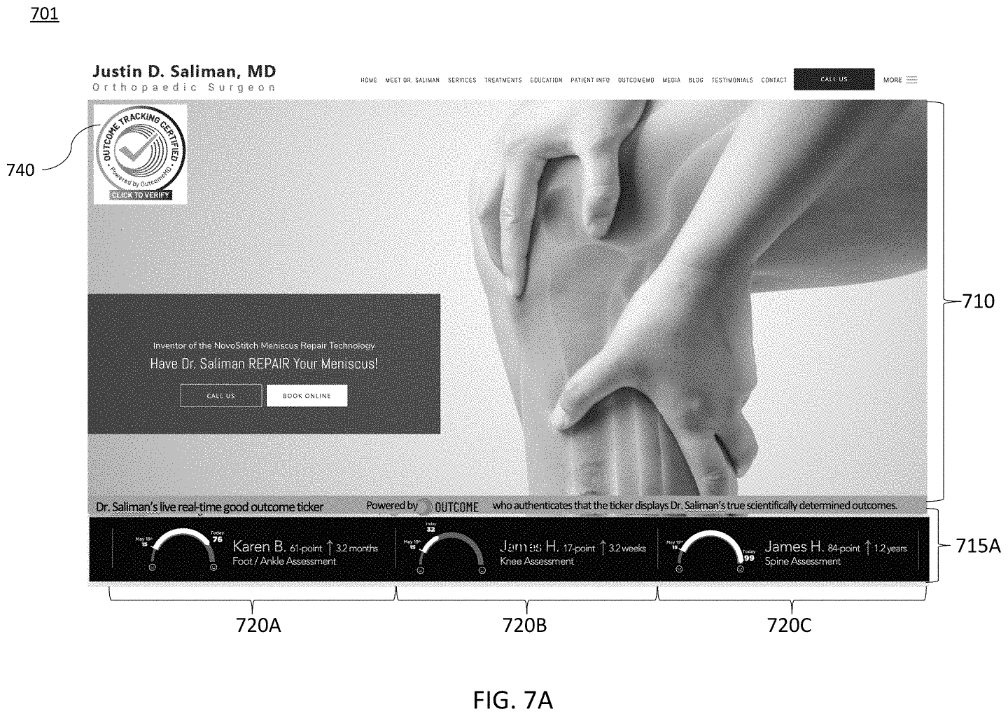

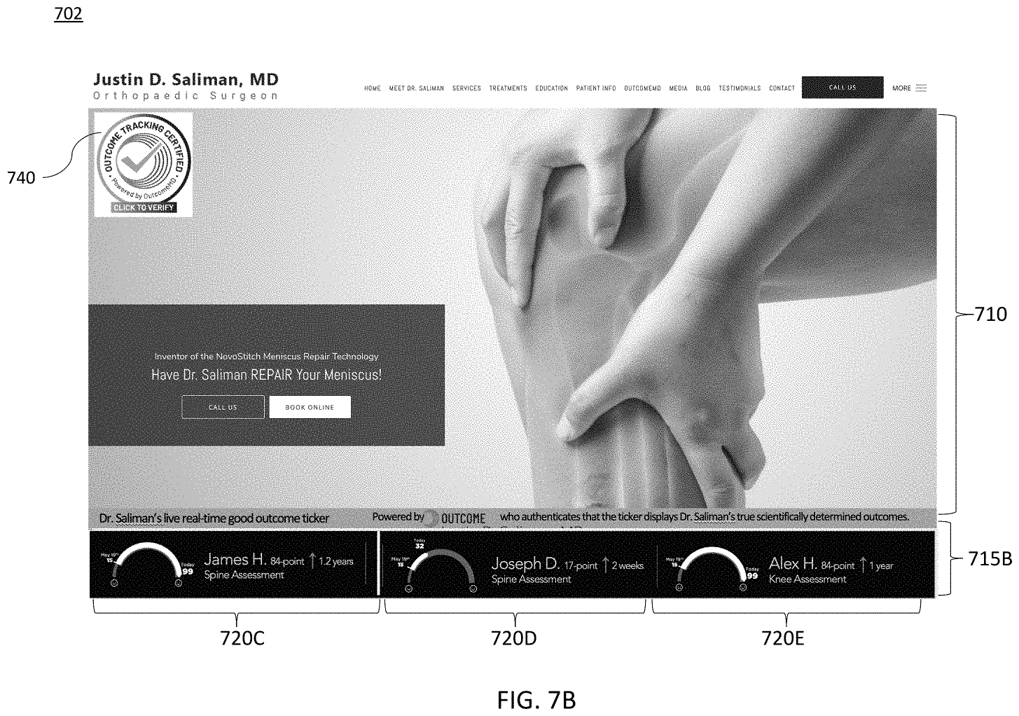

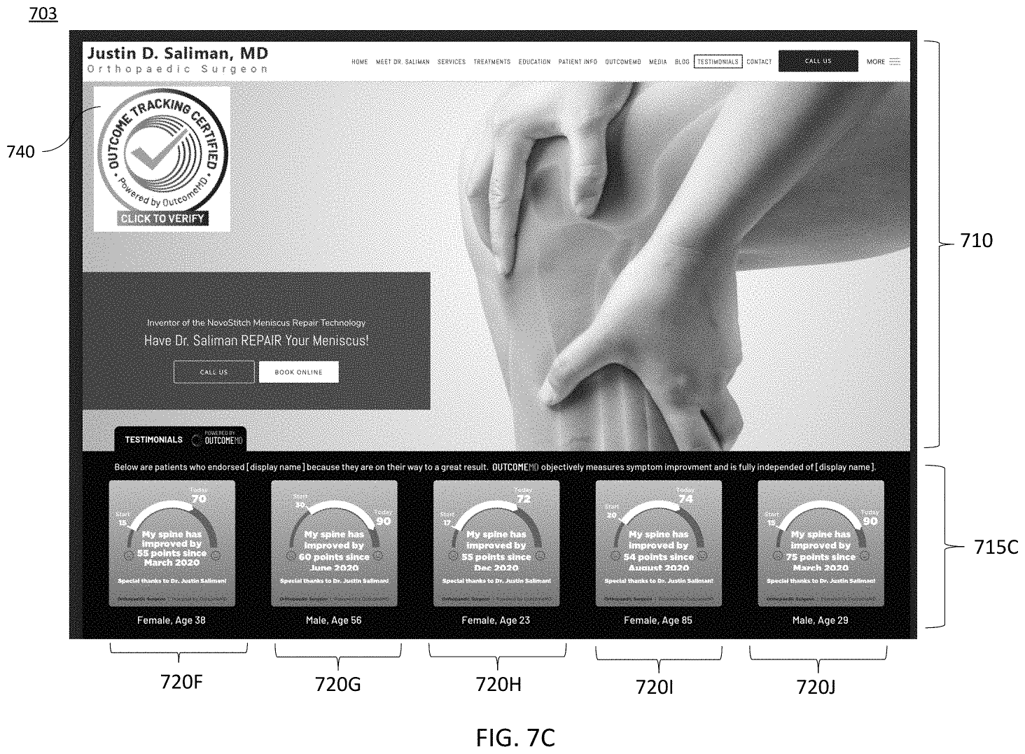

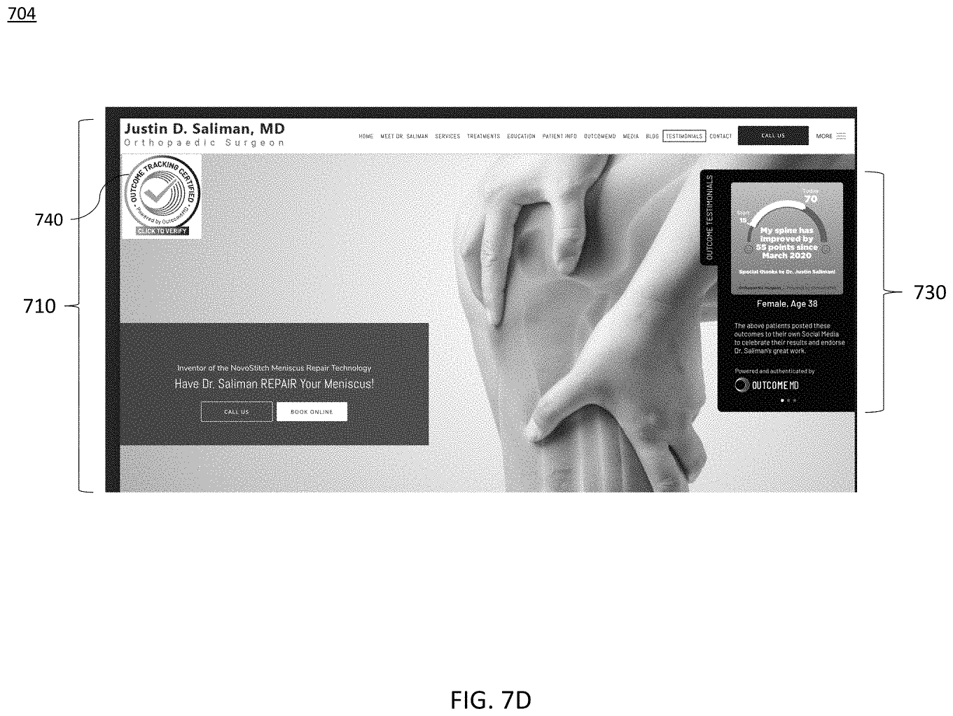

In some embodiments, system 100 may also include a provider website (or website portal) 166 and/or provider device 168 by which one or more individuals may access information from server 102 via, for example, provider website 166. Provider website 166 may be a website offered by, for example, a treatment provider and/or health-services provider (e.g., doctor, chiropractor, coach, nutritionist, physical therapist, etc.) and exemplary pages provided by provider website 166 are provide by the interfaces of FIGS. 7A-9C.

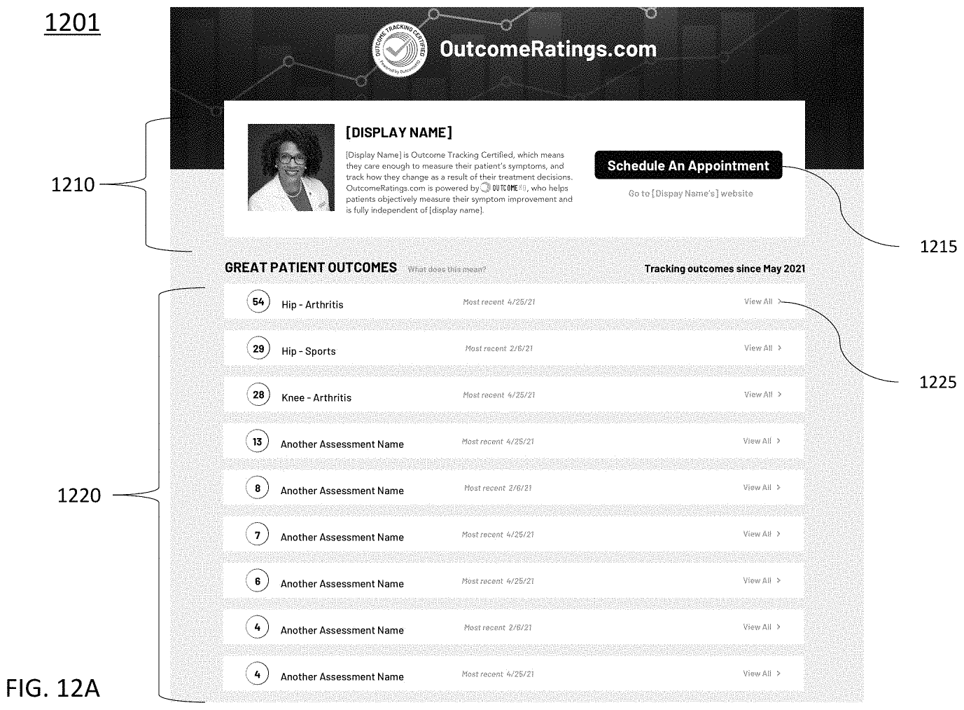

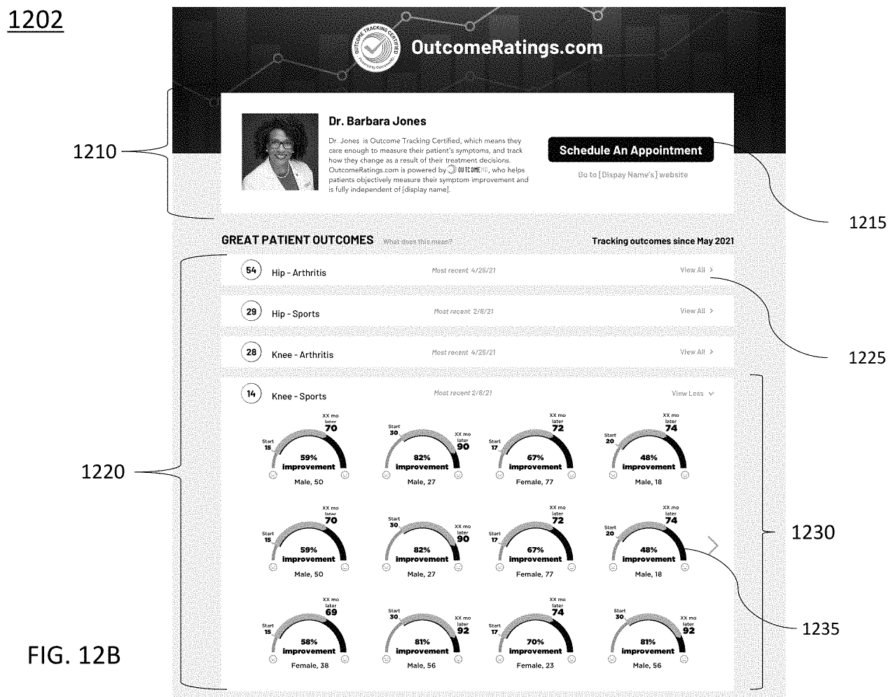

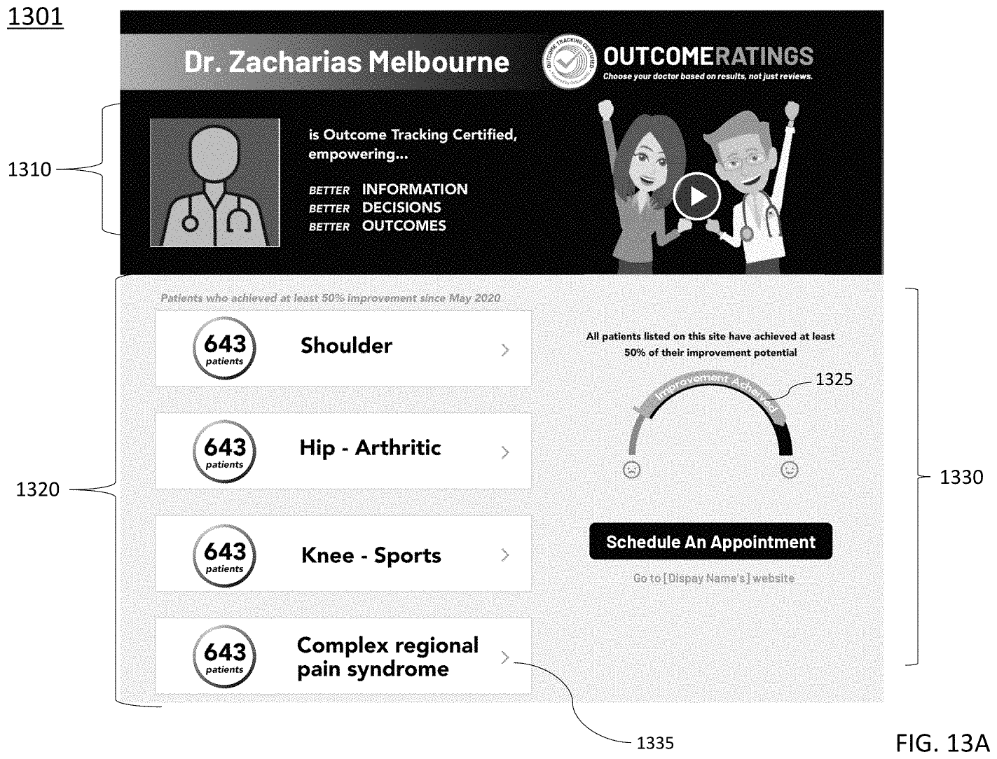

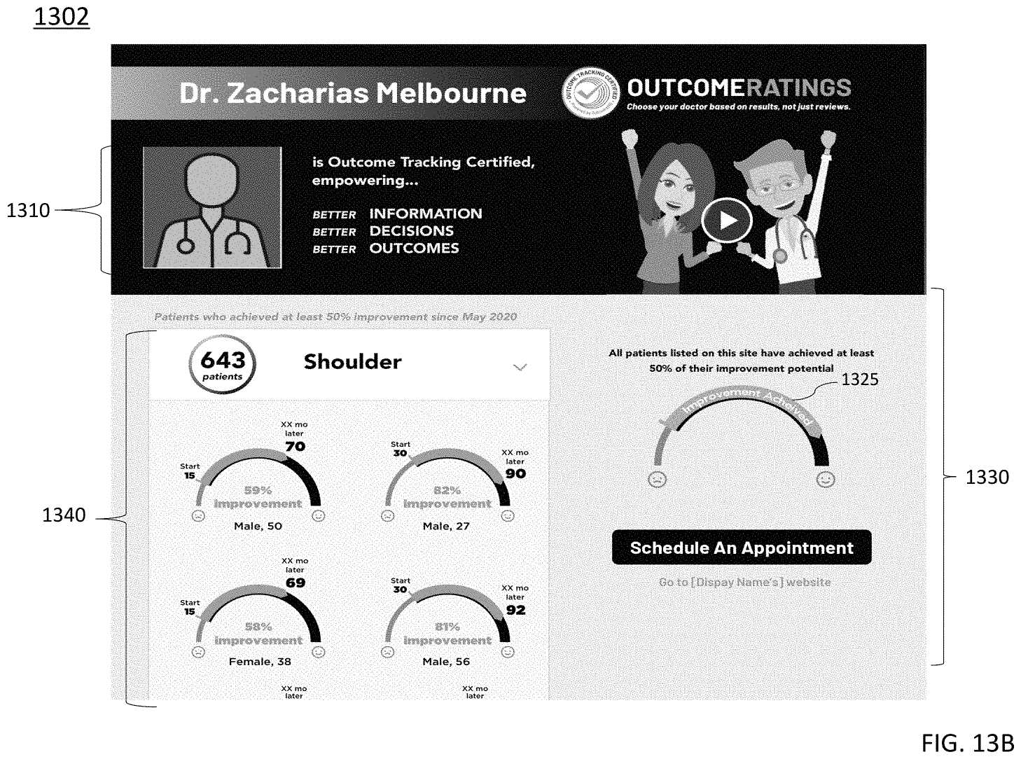

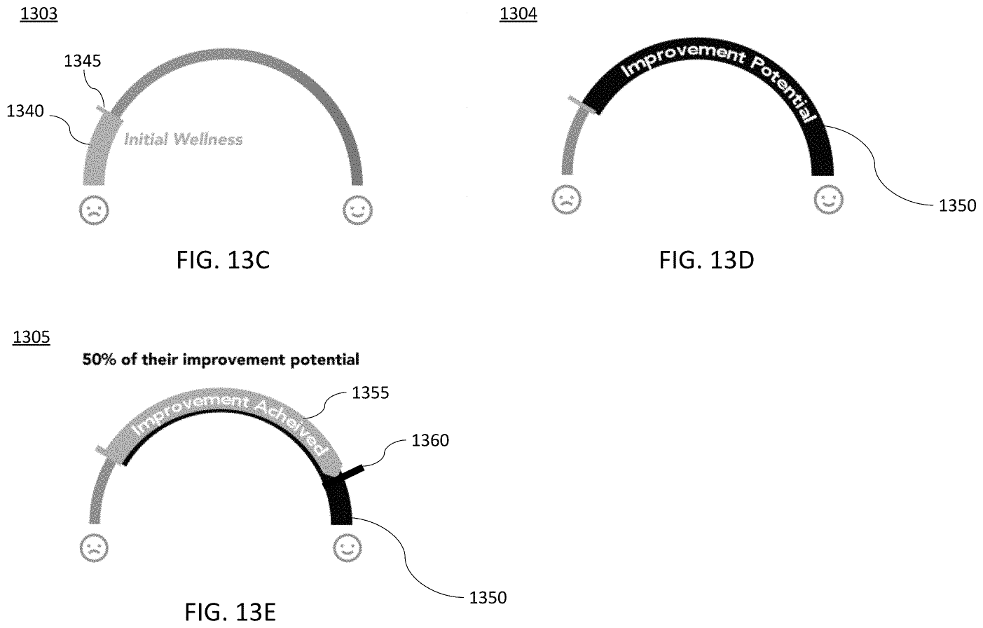

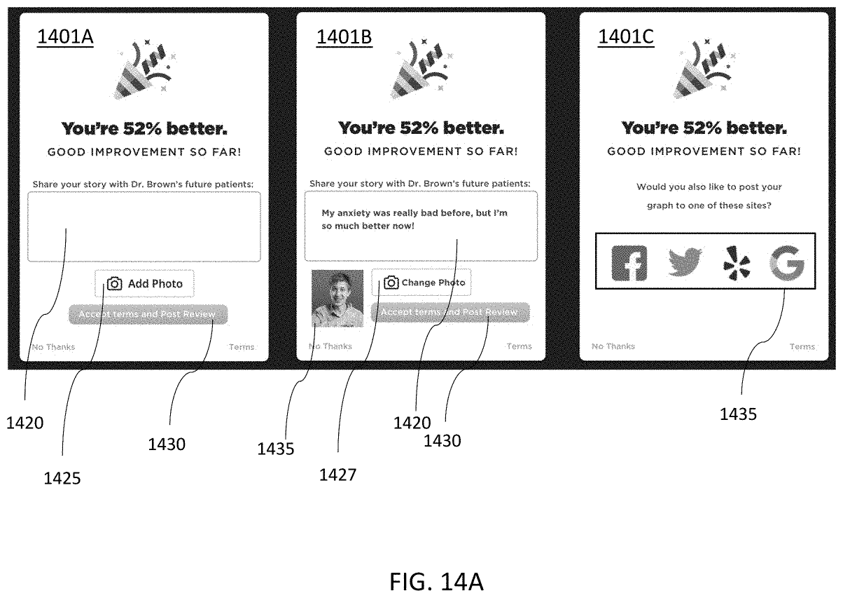

In some embodiments, system 100 may further include a ratings website 164 by which one or more ratings, messages, social media posts, wellness scores, and/or improvement scores determined via, for example, one or more processes described herein for patients associated with a treatment provider may be provided to, for example, customers, patients, and/or third parties. In many cases, the ratings messages, social media posts, wellness scores, and/or improvement scores may be provided by, for example, server 102 and/or ratings, messages, social media posts generator 140 and/or OMD response analyzer 118. Exemplary pages provided by ratings website 164 are provided by the interfaces of FIGS. 12A-13E.

In some embodiments, rating website 164 may be controlled, hosted, and/or operated by server 102 directly and/or through, for example, communication interface 101 and/or 28. Additionally, or alternatively, rating website 164 may be controlled, hosted, and/or operated by another server and/or web hosting service, which is not shown in FIG. 1A.

Although exemplary communication paths between components of system 100 are depicted in FIG. 1A, additional and/or alternative communication paths are also contemplated by various embodiments of the invention. These additional and/or alternative communication paths may by wireless and/or wired communication paths that may be facilitated by, for example, a computer network such as the Internet.

FIG. 1B depicts one embodiment of a system 150 that supports the operation of OMD response analyzer 118 and score database 120 (and some associated components). OMD response analyzer 118 may comprise wellness score determination module 152. In one embodiment, wellness score determination module 152 retrieves responses to an OMD from OMD response database 110, and further may retrieve a scoring procedure associated with the OMD responses from scoring procedure database 116. The scoring procedures may be indexed by, for example, an identifier of an OMD, for which responses have been received, making for easy retrieval of a corresponding scoring procedure. Various scoring procedures may be employed to score a completed OMD, and in one embodiment, the generated score may be known as a “wellness score”. In some cases, a “wellness score” may serve to indicate how severe a patient's symptoms are. In these cases, a low wellness score may indicate that a patient's symptoms are relatively more severe than a higher wellness score such that a subsequent higher wellness score indicates an improvement (i.e., decrease in severity) in the symptoms.

In the case where an OMD is a questionnaire (or PRO instrument), a certain weighting may be used to score or evaluate the patient's responses. For example, certain responses that are more objective in nature (e.g., heart rate, blood glucose level, etc.), may receive greater weights (and hence have a greater influence on the wellness score) than certain responses that are more subjective in nature (e.g., degree of pain, mood, etc.). The reverse scenario, of course, could be true in which subjective responses receive a greater weight than objective responses (e.g., fatigue or mental illness). Scores generated by wellness score determination module 152 may be stored in wellness score database 154. The wellness scores may be indexed in various fashions, for ease of retrieval. In one embodiment, wellness scores may be indexed according to one or more of a patient identifier (e.g., binary string to protect patient privacy), medical condition, treatment provider, health-services provider, treatment facility, time at which OMD was completed, etc.

Improvement score determination module 156 may retrieve two wellness scores for a patient (e.g., a first score calculated for an OMD completed at a first time point and a second score calculated for an OMD completed at a second time point) from wellness score database 154. Improvement score determination module 156 may calculate the difference between the first and second score, and such difference may be known as an improvement score. The improvement score may be stored in improvement score database 158. In one case, a relative improvement score may be calculated as the improvement score (i.e., the difference described above) normalized by a maximum improvement score, which may be calculated based on, for example, other considerations 132 stored in a patient's EMR. The maximum improvement score may take into consideration other factors such as the state of a patient prior to a medical treatment (e.g., if patient was in fairly good health, the maximum improvement score might be lower than if the patient was in poor health), and/or the age of a patient (e.g., younger patients might have a higher maximum improvement score than older patients), etc. An improvement score (or a relative improvement score) may be stored in improvement score database 158. The improvement scores may be indexed in various fashions, for ease of retrieval. In one embodiment, improvement scores may be indexed according to one or more of a patient identifier (e.g., binary string to protect patient privacy), medical condition, treatment provider, medical-services provider, treatment facility, and time duration over which improvement score was measured, etc.

The components and/or databases of systems 100, 150, and/or 103 of FIGS. 1A and/or 1B may be a series of one or more components (e.g., computers, servers, databases, etc.) that may, in some instances, be geographically disparate.

As disclosed herein, a wellness score and/or an improvement score for one or more aspects of the patient's medical condition and/or physiological systems may then be determined by scoring responses to one or more assessments, which in some cases may be patient reported outcome (PRO) assessments that have been validated to assess a patient's medical condition via medical literature and/or accepted best practices within the medical field. In some embodiments, determination of a wellness score may include querying a scoring database like scoring procedure database 116, for a scoring metric and/or scoring procedure associated with the medical questionnaire provided in step 305. In some instances, this querying may include retrieving a scoring procedure from scoring procedure database 116 using an identifier of the medical questionnaire. For instance, a medical questionnaire may be associated with a code (e.g., 3232) and this code may be used to retrieve a scoring procedure from scoring procedure database 116. Example scoring procedures include taking an average of all the patient responses (e.g., assuming all responses are numeric), taking a weighted average of the patient responses (e.g., weighting certain responses higher than other responses), adjusting the range of patient responses (e.g., changing responses choices from 2, 3, 3 to 1, 4, 6). In some embodiments, determining a wellness score may include retrieval of a sub-scoring procedure that may be specific to the patient (i.e., associated with the patient's account and/or a comorbidity of the patient) as may be indicated by, for example, the patient's account and/or EMR. The scored responses may then be used to determine a wellness score associated with the received responses and/or a sub-set of received responses.

An improvement score (or percentage change) may be a determination of how a patient's condition has changed over time. In some embodiments, determination of an improvement score may involve comparing (e.g., averaging, subtracting, determining a percentage change, determining a time weighted average, etc.) one or more previously determined wellness scores with a currently determined wellness score in order to determine how a patient's wellness score has changed over time (e.g., 3 weeks, 3 months, 1 year, etc.).

Rating, message, and/or post generator 140 may be configured to generate one or more posts and/or messages for display on an online platform associated with a sender of a medical questionnaire as described herein according to one or more processes described herein via communication with one or more components of system 100 such as score database 120, OMD response database, score database 120, scoring procedure database 116, reporting module 122, and/or system 150. In some embodiments, rating, message, and/or post generator 140 may be in communication with template database 141 to, for example, extract template messages and/or posts stored thereon. In some embodiments, rating, message, and/or post generator 140 may be configured to generate ratings, wellness scores, improvement scores, reviews, messages, graphics, and/or social media post(s) that are optimized for search engines that may crawl a website on which they are published so that, for example, websites and/or entities (e.g., doctors, medical facilities, treatments, etc.) may increase their respective rankings and/or popularity in a list of search results when a search engine (e.g., Google, Bing, etc.) is employed by a user to search the Internet for content that may be related to the respective website and/or entity.

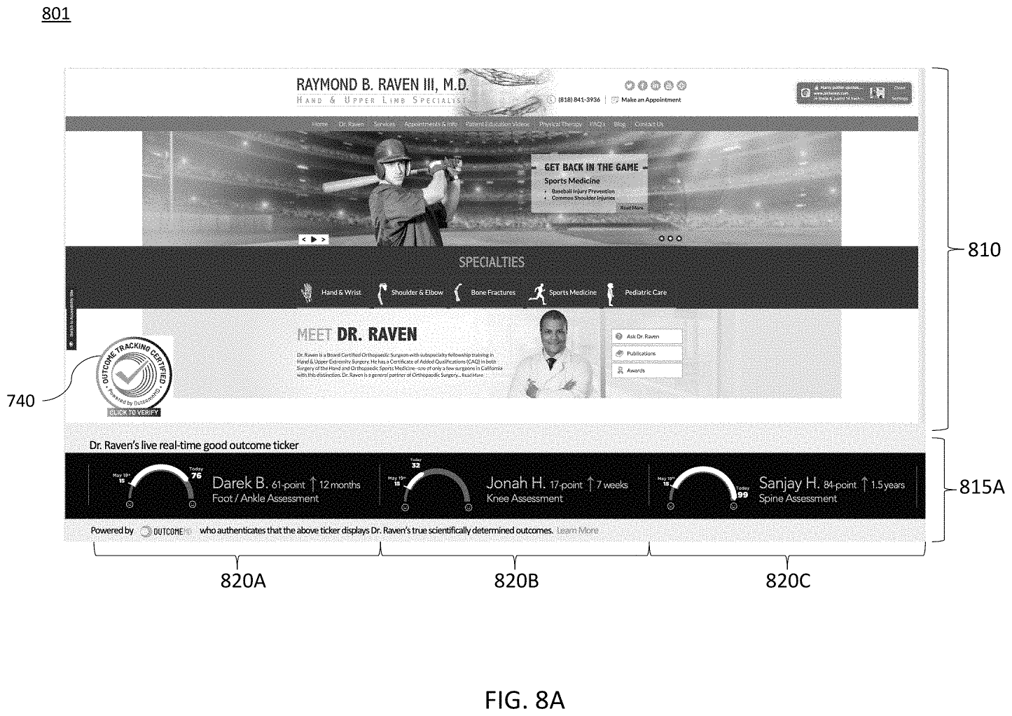

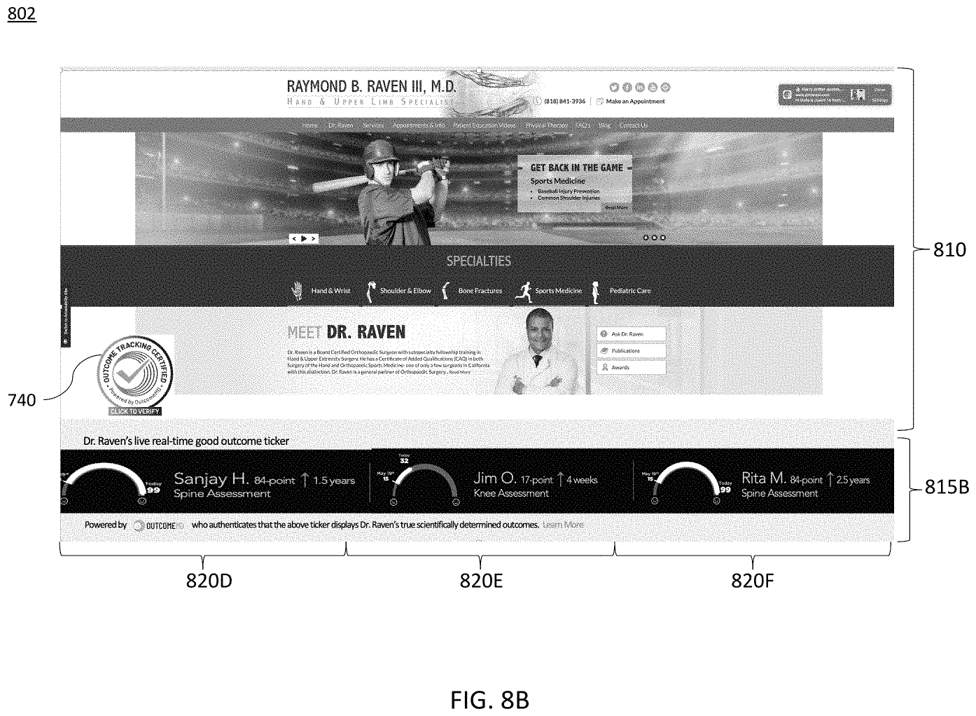

In some cases, when, for example, ratings, wellness scores, improvement scores, reviews, and/or messages are posted on and/or published to a provider website (examples of which are provided in FIGS. 7A-8B) these postings/publications may serve to optimize the website for search engines (i.e., search engine optimization) by, for example, increasing the refresh rate of content on the respective website, increasing the hyperlinks provided by the respective website, increasing the interconnectedness of the respective website with other websites/online resources.

FIG. 1C is a block diagram showing a system 10 that includes a bus 12 or other communication mechanism for communicating information, and a processor 14 coupled with the bus 12 for processing information. Computer system 10 also includes a main memory 16, such as a random-access memory (RAM) or other dynamic storage device, coupled to the bus 12 for storing information and instructions to be executed by processor 14. Main memory 16 also may be used for storing temporary variables or other intermediate information during execution of instructions to be executed by processor 14. Computer system 10 further includes a read only memory (ROM) 18 or other static storage device coupled to the bus 12 for storing static information and instructions for the processor 14. A storage device 20, for example a hard disk, flash memory-based storage medium, or other storage medium from which processor 14 can read, is provided and coupled to the bus 12 for storing information and instructions (e.g., operating systems, applications programs and the like).

Computer system 10 may be coupled via the bus 12 to a display 22, such as a flat panel display, for displaying information to a computer user. An input device 24, such as a keyboard including alphanumeric and other keys, may be coupled to the bus 12 for communicating information and command selections to the processor 14. Another type of user input device is cursor control device 26, such as a mouse, a track pad, or similar input device for communicating direction information and command selections to processor 14 and for controlling cursor movement on the display 22. Other user interface devices, such as microphones, speakers, etc. are not shown in detail but may be involved with the receipt of user input and/or presentation of output.

The processes referred to herein may be implemented by processor 14 executing appropriate sequences of computer-readable instructions contained in main memory 16. Such instructions may be read into main memory 16 from another computer-readable medium, such as storage device 20, and execution of the sequences of instructions contained in the main memory 16 causes the processor 14 to perform the associated actions. In alternative embodiments, hard-wired circuitry or firmware-controlled processing units may be used in place of or in combination with processor 14 and its associated computer software instructions to implement the invention. The computer-readable instructions may be rendered in any computer language.

In general, all of the above process descriptions are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 10 or similar electronic computing device, that manipulates and transforms data represented as physical (electronic) quantities within its registers and memories into other data similarly represented as physical quantities within its memories or registers or other such information storage, transmission or display devices.

Computer system 10 also includes a communication interface 28 coupled to the bus 12. Communication interface 28 may provide a two-way data communication channel with a computer network, which provides connectivity to and among the various computer systems discussed above. For example, communication interface 28 may be a local area network (LAN) card to provide a data communication connection to a compatible LAN, which itself is communicatively coupled to the Internet through one or more Internet service provider networks. The precise details of such communication paths are not critical to the present invention. What is important is that computer system 10 can send and receive messages and data through the communication interface 28 and in that way communicate with hosts accessible via the Internet. It is noted that the components of system 10 may be located in a single device or located in a plurality of physically and/or geographically distributed devices.

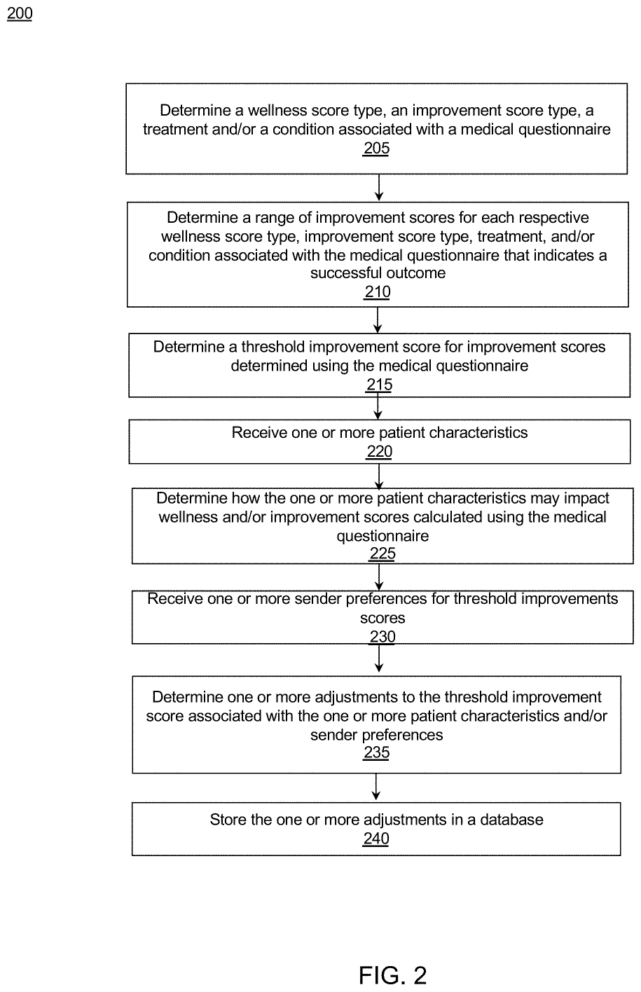

FIG. 2 provides a flowchart illustrating a process for determining a threshold improvement score. Process 200 may be executed by, for example, any of the systems and/or system components disclosed herein.

In step 205, a type of wellness score, a type of improvement score, a treatment, and/or a condition associated with a medical questionnaire and/or a group of medical questionnaires used to determine a wellness and/or improvement score. Exemplary wellness scores and/or improvement scores may be determined as disclosed herein. For example, a wellness score for a patient may be determined via execution of steps 305-320 of process 300, described below and an improvement score may be determined via execution of steps 325-330 of process 300.

In some embodiments, types of wellness scores, types of improvement scores, treatments and/or conditions may be categorized according to, for example, severity, impact to the general health and wellness of patient, typical persistence of a medical condition, expected amounts (e.g., full, 75%, 50%) of recovery, and/or expected rates of recovery (days, weeks, months, years).

In step 210, a range of improvement scores for each respective wellness score type, improvement score type, treatment, and/or condition associated with the medical questionnaire that indicates a successful outcome is determined. A successful outcome may be an improvement score with an absolute value (e.g., 10%) in all circumstances regardless of treatment and/or condition, or an improvement score with an absolute value (e.g., 10% or 30%) in particular circumstances (e.g., an improvement score of 10% for a cortisone shot treatment for a spinal injury or an improvement score of 90% for recovery from cataract surgery). Additionally, or alternatively, a successful outcome may be relative to, for example, the wellness score type, improvement score type, treatment, condition, and or timeline for recovery from a condition or treatment.

In step 215, a threshold improvement score for improvement scores determined using the medical questionnaire may be determined. How this threshold improvement score may be used is discussed below. A threshold improvement score may be an absolute value (e.g., 10%) in all circumstances regardless of treatment and/or condition, an absolute value (e.g., 10% or 30%) in particular circumstances (e.g., a low threshold for treatments known to have long recovery timelines or limited degrees of recovery as with a chronic illness e.g., an improvement score of 10% for a cortisone shot treatment for a spinal injury or an improvement score of 90% for recovery from cataract surgery). Additionally, or alternatively, a threshold improvement score may be relative to, for example, the wellness score type, improvement score type, treatment, condition, and or timeline for recovery from a condition or treatment.

Additionally, or alternatively, a threshold improvement score may be set following statistical analysis of a plurality of wellness and/or improvement scores taken over a range of time for a plurality of patients so that, for example, statistically determined trajectories for improvement for various medical conditions, diagnoses, and/or treatments may be determined and therefore used to set improvement score thresholds for various medical questionnaires.

In some embodiments, setting a threshold for a medical questionnaire may be responsive to a timeline for treatment and/or recovery from a treatment for patient. It is sometimes the case that patients improve from some treatments more rapidly immediately following the treatment and then continue to improve over time at a slower rate. For example, when recovering from a knee replacement surgery, a patient may experience rapid recovery between an initial wellness score taken the day after the surgery (e.g., not being able to put any pressure on the affected leg immediately following the treatment) and a wellness score determined four weeks following the surgery (e.g., able to walk on crutches). The same patient may be expected to experience a slower rate of recovery a few months following the treatment so an improvement score determined using wellness scores at four and five months following surgery may be lower because the change in the patient's mobility and pain when comparing month four and five in recover may be less significant than it was in the first month following the treatment but still within an expected range of recovery for the treatment at the time following treatment. Thus, an improvement score threshold set for the first four weeks following a knee replacement surgery may be higher than an improvement score threshold set that measures improvements between the patient's condition between the fourth and fifth months following the surgery because the expected rate of recovery (i.e., improvement) between fourth and fifth months following the surgery is lower than the expected rate of recovery (i.e., improvement) between the day after the surgery to one month following the surgery.

In some cases, full recovery from a medical condition, such as a chronic illness (e.g., asthma, chronic obstructive pulmonary disease (COPD), arthritis, diabetes) is not possible and treatment is administered overtime to manage symptoms of the underlying medical condition. In these cases, “improvement” of wellness scores taken overtime may be minimal and, in some instances, maintaining a consistent wellness score and/or improvement score and/or keeping a wellness score and/or improvement score within a particular range may be the desired, or best possible, outcome. In these instances, an improvement score and/or a wellness score threshold may be set accordingly so. For example, when managing chronic illness and/or terminal illness for a patient, slowing with the decline of the patient's medical condition may be the desired, or best outcome. In these cases, an improvement score threshold that is a low number (e.g., −10%, −5%, or 0) may be set.

Additionally, or alternatively, a threshold improvement score may be set following statistical analysis of a plurality of wellness and/or improvement scores taken over a range of time for a plurality of patients so that, for example, statistically determined trajectories for improvement for various medical conditions, diagnoses, and/or treatments may be determined and therefore used to set improvement score thresholds for various medical questionnaires.

Optionally, in step 220, one or more patient characteristics (e.g., demographic information, comorbidities, medications the patient is taking, etc.) may be received and it may be determined how the received patient characteristic(s) may impact wellness and/or improvement scores calculated using the medical questionnaire (step 225). Then, one or more adjustments to the threshold improvements for associated with the one or more patient characteristics may be determined (step 235). Additionally, or alternatively, in some embodiments one or more sender preferences for a threshold improvement score may be received (step 230) and these thresholds may be incorporated into a determined threshold improvement score (step 235).

In step 240, the one or more adjustments to the threshold improvement score and/or the associations between the adjustments and the patient characteristics and/or sender preferences may be saved in a database like score database 120.

In some embodiments, process 200 may end following execution of step 215. However, at times, steps 220-225 and/or step 230 may be performed to determine one or more adjustments to the improvement score threshold. In some cases, these adjustments may be case (e.g., patient or gender) and/or patient characteristic specific.

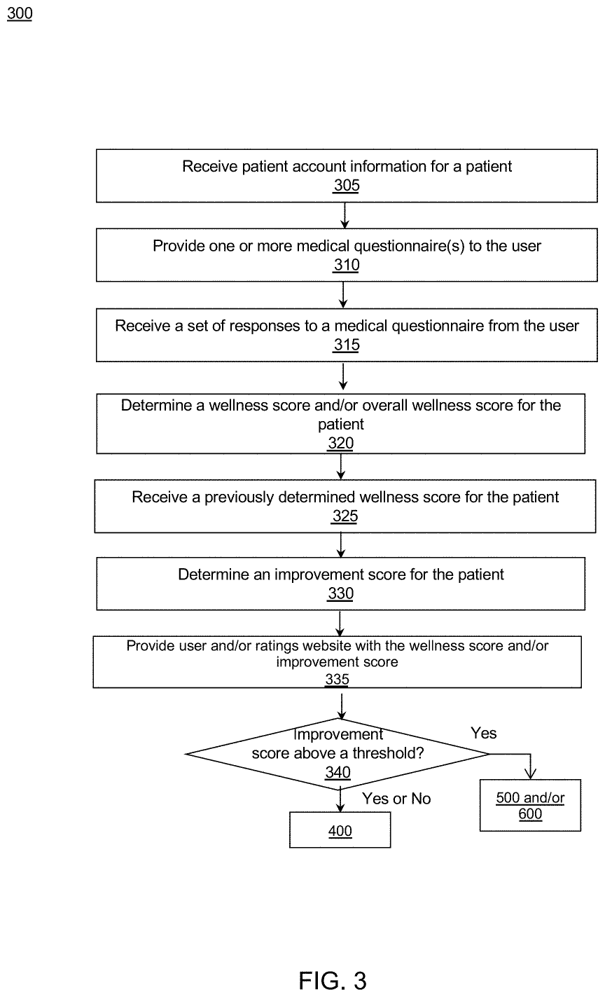

FIG. 3 provides a flowchart illustrating a process 300 for determining a wellness and/or improvement score for a patient and determining whether the improvement score is above a pre-determined threshold. Process 300 may be executed by, for example, any of the systems and/or system components disclosed herein.

In step 305, patient account information may be received from a user. Exemplary users include, but are not limited to, the patient associated with the patient account, a caregiver for the patient, a public relations professional working with/for the patient, and/or a medical treatment/care provider for the patient. The patient account information may be, for example, patient account log in information (e.g., biometric data, a username, and/or a password) and/or patient account administrator information, which may also be, for example, biometric data, a username, and/or a password.

In some embodiments, the patient account may be set up by, and/or associated with (e.g., linked to and/or in communication with) a sender of a medical questionnaire who may be, directly or indirectly, a treatment provider and/or medical-services provider who provides one or more treatments/medical services to the patient. The patient and/or user may interact with his or her patient account via, for example, a software application running on a personal electronic device (e.g., smart phone or tablet computer) such as patient device 128 and/or user device 124. The software application may be configured to provide communicate with the patient and/or user via, for example, a display device and communication interface (e.g., touch-sensitive display, keyboard, etc.). Further details about the hardware used to facilitate communication between the software program the patient/user and the treatment provider are provided below with regard to FIG. 1C.

In step 310, one or more OMDs and/or medical questionnaires (OMDs and medical questionnaires may be collectively referred to herein as a “medical questionnaire”) may be provided to the patient/user. In some instances, the electronic device is owned and/or operated by the patient or user as their personal electronic device. In other instances (e.g., when the patient or user does not have a personal electronic device), the one or more medical questionnaires may be provided to an electronic device operated by, for example, a medical facility or physician. On some occasions, step 310 may be executed by the software program running on the personal electronic device the patient/user is using and the medical questionnaire may be provided to the user by way of a graphic user interface the patient and/or user may view the medical questionnaire(s) and provide responses thereto.

In some embodiments, step 310 is executed responsively to an action by, for example, the patient, user, and/or treatment provider as a way to, for example, gather information about the patient's primary complaint or medical concern, the patient's general state of health, the patient's wellness with regard to one or more medical conditions and/or treatments, and/or the patient's improvement (or lack thereof) with regard to one or more medical conditions and/or treatments.

In step 315, a set of responses to the one or more medical questionnaire(s) may be received by, for example, a processor like processor 604 and/or server like server 102 via, for example, direct entry of responses into an interface, or GUI, provided in step 310 and, in some embodiments, communication of the set of responses from, for example, a patient device like patient device 128, user device 124, and/or a treatment provider device like treatment provider device 125 to the server.

A wellness score and/or an improvement score for one or more aspects of the patient's medical condition and/or physiological systems may then be determined (step 320). In some embodiments, determination of a wellness score may include querying a scoring database like scoring procedure database 116, for a scoring metric and/or scoring procedure associated with the medical questionnaire provided in step 310. In some instances, this querying may include retrieving a scoring procedure from scoring procedure database 116 using an identifier of the medical questionnaire that may, in some cases, be associated with, for example, the medical questionnaire and/or patient account. For instance, a medical questionnaire may be associated with a code (e.g., 3232) and this code may be used to retrieve a scoring procedure from scoring procedure database 116 and a scale (e.g., 1-5, 1-40, 1-85) for the scoring of the medical questionnaire. Exemplary scoring procedures include taking an average of all the patient responses (e.g., assuming all responses are numeric), taking a weighted average of the patient responses (e.g., weighting certain responses higher than other responses), and/or adjusting a scale of patient responses. In some instances, where, for example, a plurality of medical questionnaires are provided to the user, a score for each medical questionnaire may be determined and these scores may be combined into a single wellness score (referred to herein as an overall wellness score) by, for example, normalizing a scale for scoring each of the medical questionnaires to a single scale (e.g., 1-10 or 1-100) and averaging or applying a weighted average to the plurality of wellness scores that are determined.

In some embodiments, a single wellness score determined in step 320 may combine the scoring two (or more) different medical questionnaires, which for the purpose of this example will be labeled MQ1 and MQ2 respectively. Determining the single wellness score may involve scoring MQ1 and MQ2 using their respective scoring procedures, normalizing a scale of the score for MQ1 and MQ2 to be on a single scale of, for example, 1-100, and then averaging the normalized scores for MQ1 and MQ2. Alternatively, the score for MQ1 and MQ2 may be normalized to be on a single scale of, for example, 1-50 and then the score for MQ1 and MQ2 may be added together to generate a wellness score on a 1-100 scale.

Additionally, or alternatively, execution of step 320 may include retrieval of a sub-scoring procedure that may be specific to the patient (e.g., associated with the patient's account or a comorbidity of the patient) as may be indicated by, for example, the patient's wellness account and/or EMR. The scored responses may then be used to determine an overall wellness score associated with the received response and/or a sub-set of received responses.

Then, in step 325, a previously determined wellness score for the patient may be received via, for example, querying memory 1206, storage device 1210, the patient account, patient account database 142, and/or an EMR database such as patient EMR database for one or more of the patient's previously determined wellness scores. In some embodiments, the received previously determined wellness score may be an initial pre-treatment wellness score. Additionally, or alternatively, when, for example, there are a plurality of previously determined wellness scores for the patient, the queried for/received previously determined wellness score may be the most recent previously determined wellness score, and/or an average of a set (2, 4, 8, 10, 20, etc.) of previously determined wellness scores.

For embodiments where more than one wellness score or sub-score was determined in step 320, a query for a wellness score may include a request for multiple types of previously determined wellness scores that were incorporated into the overall wellness score determined in step 320 so that the components of the overall wellness may be collectively and/or individually received and/or analyzed.

In step 330, an improvement score for the patient may be determined by, for example, comparing the wellness determined in step 320 with the previously determined wellness score received in step 325 so that a change therebetween may be determined. This change may represent how a patient's condition has changed (e.g., improved and/or declined) over time. For example, in some embodiments, determination of an improvement score may involve comparing (e.g., averaging, subtracting, determining a percentage change, determining a time weighted average, etc.) the received previously determined wellness scores with wellness score determined in step 320 in order to determine how a patient's wellness score has changed over time (e.g., 3 weeks, 3 months, 1 year, etc.). The improvement score may be, for example, a percentage change in wellness score and/or a numerical value.

For embodiments where, a single wellness score determined in step 320 includes scoring two different medical questionnaires, execution of step 330 may include determining a change in each of the scores MQ1 and MQ2 between a presently and previously determined score for MQ1 and MQ2 respectively and/or determining a change in the presently and previously determined single wellness scores.

In step 335, the user and/or a ratings website like ratings website 164 may be provided with the wellness score and/or the improvement score via, for example, communicating same to a patient device like patient device 128 via a user interface or graphical user interface that may be displayed on a display device of, for example, the patient device and/or user device

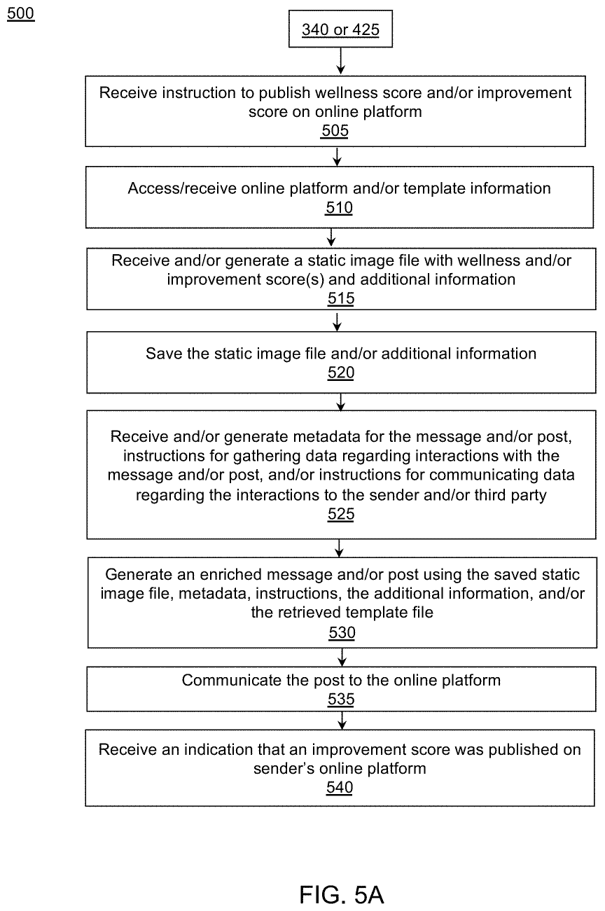

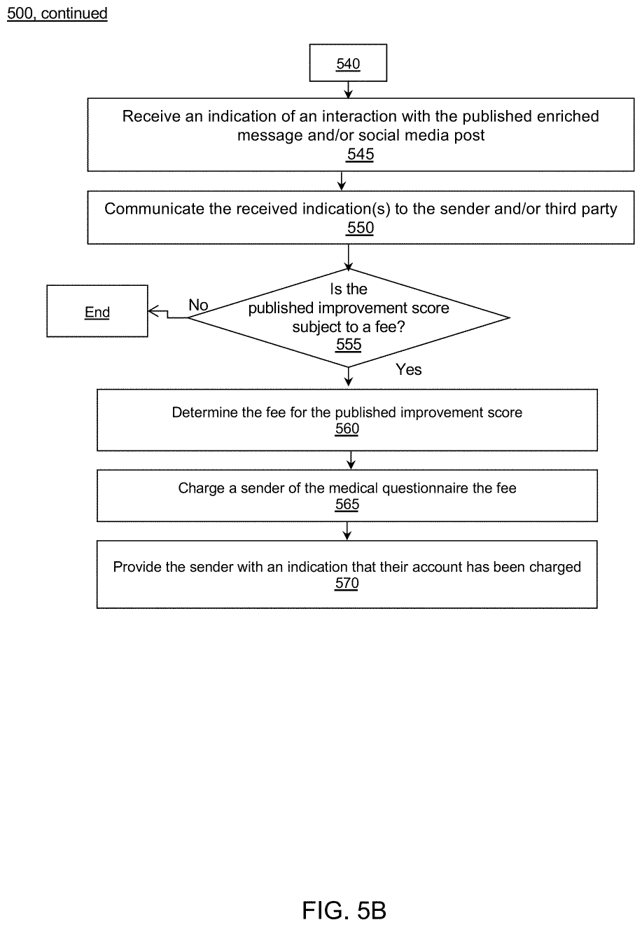

In step 340 of process 300, it may be determined whether an improvement score determined in step 330 is above a threshold. In some embodiments, the threshold improvement score may be determined via execution of process 200 or a portion thereof. Exemplary thresholds include, but are not limited to, 0% (indicating no improvement), 10%, 20%, 25%, 30%, 50%, 75%, or 80% higher than a previously determined wellness score; a numerical value for an improvement score (e.g., 5, 10, 30) and, in some cases, may be set by an associate of the patient (e.g., employer), a sender of the medical questionnaire, a clinician, treatment center, and/or medical administrator who, in some cases, may be have requested that the user be provided with the medical questionnaire in step 310. In some instances, the threshold may be referred to herein as an endorsement threshold and, at times, when the improvement score is above the endorsement threshold, a user may be prompted to provide an endorsement of, for example, a medical treatment provider, a medical treatment facility, a treatment, and/or a course of action (e.g., diet or exercise program) as explained below with regard to, for example, process 500 shown in FIGS. 5A and 5B.

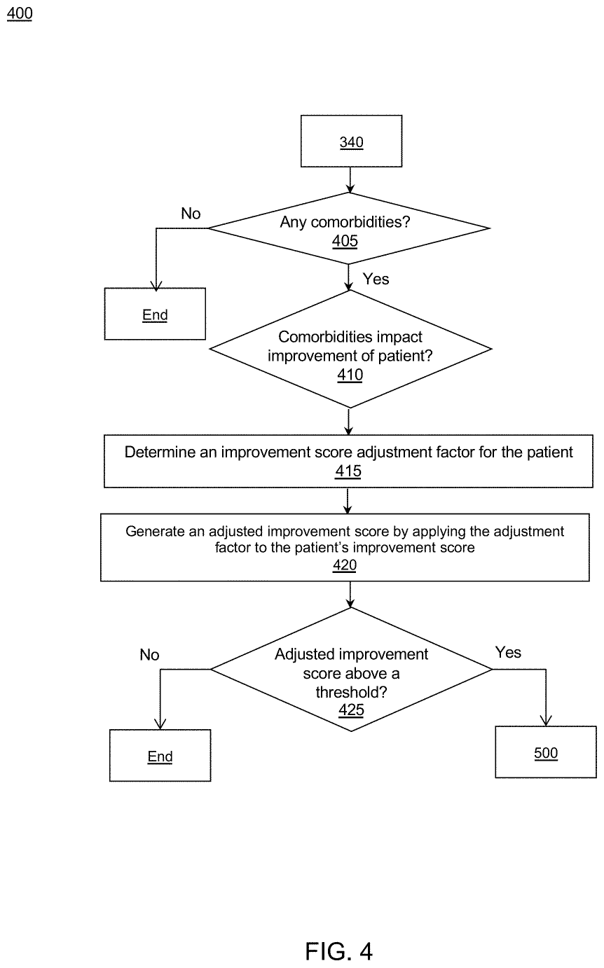

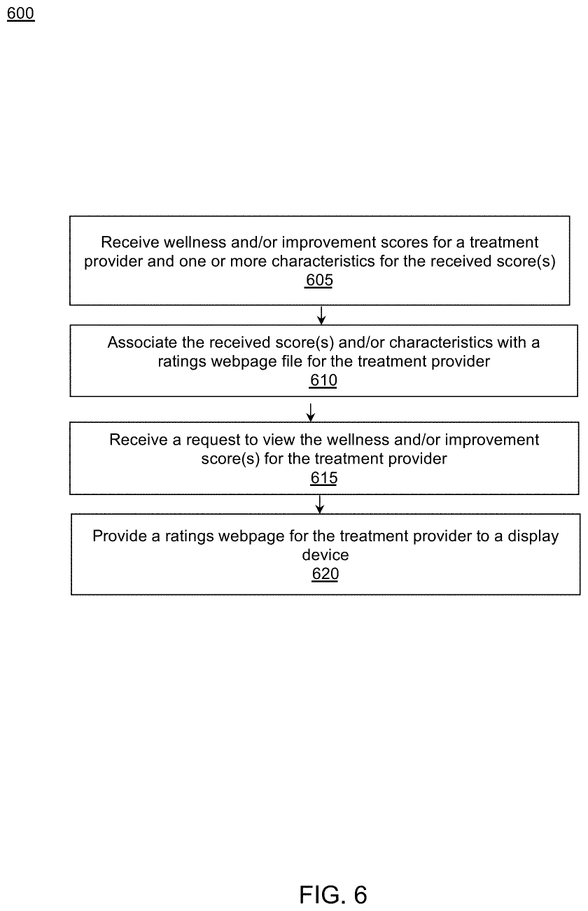

When the improvement score is above the threshold, process 300 may advance to process 400, described below with regard to FIG. 4. Additionally, or alternatively, whether the improvement score is above the threshold or not, process 300 may advance to process 500 and/or 600, described below with regard to FIGS. 5 and 6, respectively.

FIG. 4 is a flowchart of an optional exemplary process 400 for determining an adjusted improvement score for the patient. Process 400 may be executed by any of the systems or system components disclosed herein. Optionally, process 400 may be executed following execution of step 340 regardless of whether the improvement score is above a threshold. However, optional process 400 is most likely to be executed when it is determined in step 340 that the improvement score is below the threshold.

In step 405, it may be determined whether the patient has any comorbidities by, for example, asking the patient whether or not he or she has any comorbidities and/or querying patient EMR and/or patient account information that may be stored in, for example, memory 1206, storage device 1210, patient account database 142, and/or patient EMR database 130. Exemplary comorbidities include, but are not limited to, a diagnosed medical condition, an injury, and an adverse life event (e.g., death in the family, divorce, job loss, etc.). When the patient does not have any comorbidities, process 400 may end. When the patient does have a comorbidity, it may be determined whether that comorbidity impacts and ability for an improvement in a medical condition the patient is diagnosed with and/or recover from a treatment the patient has received (step 410) and an improvement score adjustment factor for the patient's improvement may be determined (step 415). The adjustment factor may be, for example, a percentage and/or a statistical weight that is applied to what are more factors in the calculation of the patient's improvement score and/or the overall determined improvement score for the patient. Execution of step 410 may include determining whether the comorbidity is relevant to the patient's diagnosis and/or treatment received. For example, if the patient has the comorbidity of being obese, this comorbidity may impact how quickly the patient is able to recover from knee replacement surgery but may not impact how quickly the patient is able to recover from a broken wrist. When step 410 is executed for this patient, it may be determined how much the patient's obesity impacts his or her ability to recover from the knee replacement surgery and adjustment factor for the improvement score of the patient may be determined.

In step 420, an adjusted improvement score may be generated by applying the adjustment factor to the patient's improvement score. Then, in step 425, it may be determined whether the adjusted improvement score is above a threshold which may be the threshold of step 340 and/or a different threshold that incorporates the adjustment factor of step 415 and/or the comorbidity of the patient. When the adjusted improvement score is not above the threshold, process 400 may end. When the adjusted improvement score is above the threshold, process 400 may advance to process 500, which is shown in FIGS. 5A and 5B and described below.

FIGS. 5A and 5B provide a flowchart illustrating an exemplary process 500 for preparing a message and/or a post that includes a wellness and/or an improvement score to an online platform associated with a sender of a medical questionnaire. Process 500 may be executed by, for example, any of the systems and/or system components disclosed herein.

In step 505, an instruction to publish the wellness score, the improvement score, and/or message on the online platform may be received. In some embodiments, step 505 may be executed when it is determined that the patient's improvement score is above a threshold as determined via execution of process 300 and/or 400. In step 510, information regarding the online platform and/or template information for messages and/or posts to be published on the online platform may be accessed and/or received. In some cases, step 510 may be executed by querying a website or other data store that may store APIs that may be used to generate the template and/or post. On some occasions, execution of step 510 may include querying the patient account and/or an associated treatment provider computer/database for any information to prepare a post and/or message for the online platform such as preferred posting lay out, publication time, display location on a web page, color scheme, logos, etc.

Optionally, in step 515, a static image file that includes the wellness score and/or improvement score in a particular format may be received and/or generated. In some embodiments, additional information (e.g., treatment the patient is undergoing, how long since a treatment was administered, patient/user characteristics, a treatment provider, and/or a medical facility, etc.) may also be received in step 515.

In step 520, the static image file, additional information, and/or indication of what type of message the user would like to have prepared may be saved in, for example, one or more of the databases disclosed herein.

Optionally, in step 525, metadata for the message and/or post may be received and/or generated. Additionally, or alternatively, execution of step 525 may include receiving and/or generating instructions for gathering data regarding interactions with the message and/or a post once the message and/or social media post is published, and/or instructions for communicating data regarding the interactions to the sender of the medical questionnaire and/or a third party (e.g., a third-party operator of server 102). The metadata, instructions for gathering data, and/or instructions for communicating data via execution of step 525 may be responsive to, for example, the template/information of step 510 and/or one or more preferences of, for example, the sender, the third party, or another user. In some embodiments, the metadata and/or instructions may be in the form of HTML or other executable computer software code.

In some embodiments, the metadata generated and/or retrieved for inclusion in an enriched message and/or post may include, for example, keywords relating to a condition of the patient, a treatment received by the patient, a diagnosis of the patient, a specialty of the sender and/or treatment provider, a sub-specialty of the sender and/or treatment provider, demographic information for the sender and/or treatment provider, demographic and/or comorbidity information for the patient, business information (e.g., location, practice size, board accreditations, certifications, languages spoken, etc.) for the sender and/or treatment provider, contact information (e.g., phone number, website address, and/or email address) for the sender/treatment provider, and/or social media accounts associated with the sender/treatment provider. At times, the metadata may be optimized for access by internal systems (e.g., indexes of data within an organization).

In some embodiments, the metadata and/or instructions of step 525 may include links to, for example, a website, a social media account, and/or an online review account of, for example, a sender of the medical questionnaire, a treatment provider, a treatment facility, and/or a third party. Additionally, or alternatively, the metadata and/or instructions of step 530 may include links to, for example, to social media and/or online review or ratings platforms such as YELP™ and/or GOOGLE REVIEWS™.

In some embodiments, the template information of step 510 and/or the metadata and/or instructions of step 525 may include instructions for automatically scrolling through a plurality of posts of improvement scores and/or wellness scores over time in a manner similar to, for example, a feed, or ticker tape, or marquee that displays on, for example, a bottom, top, left side, and/or right side of a page for the online platform such as a sender's website. The scrolling may be horizontal or vertical on the page and may be sent to move at a certain velocity across the page. The posts of the ticker tape may be on a loop that may be continuously updated with new posts as they become available. In addition, posts may be removed from the ticker tape once they reach a certain age (e.g., 3, 6, or 12 months).

Additionally, or alternatively, the template information of step 510 and/or the metadata and/or instructions of step 525 may include and/or access a scrolling API that is configured to set a scroll velocity or otherwise animate the posts so that a plurality of posts move across a page of the online platform of the sender. In some cases, the scrolling instructions may be adaptive to the type of device and/or screen (e.g., smart phone, computer, tablet computer, etc.) the online platform page is displayed on.

In step 530, message and/or post without metadata and/or an enriched message and/or improvement score post may be generated using the information received and/or generated via execution of process(es) 300, 400, and/or 500. Then, the post and/or message may be communicated to the online platform or website along with instructions regarding display of the post/message (step 535). Optionally, an indication that the message and/or post has been successfully published on the sender's online platform may be received (step 540).

In some embodiments, a sender of the medical questionnaire may be invoiced or charged for some, or all, of the messages and/or posts published on the online platform as part of, for example, an online reputation management and/or marketing campaign. In step 545, an indication that the message and/or post has been published to the online platform may be received. The received indication may be communicated to the sender and/or a third party (step 550) and it may then be determined whether the published message and/or post is subject to a fee or is associated with a reputation management and/or marketing campaign of the sender (step 555). When the published message and/or post is not subject to a fee or is not associated with a reputation management and/or marketing campaign of the sender, process 500 may end. When the published message and/or post is subject to a fee or is associated with a reputation management and/or marketing campaign of the sender, in step 560, a fee for the message and/or post may be determined. The sender may be charged the fee (step 565) and provided with an indication (e.g., invoice and/or receipt) that their account has been charged (step 570).

FIG. 6 provides a flowchart illustrating an exemplary process 600 for providing a ratings webpage for a treatment provider, the ratings webpage proving wellness and/or improvement scores for patients associated with the provider. Process 600 may be executed by, for example, one or more of the systems described herein.

In step 605, one or more wellness and/or improvement scores may be received. The wellness and/or improvement scores may be determined via, for example, any of the processes described herein. In many embodiments, a treatment provider identifier (e.g., name, identification number, etc.) and/or treatment facility identifier may also be received in step 605. Additionally, one or more wellness/improvement scores, patient, and/or treatment provider characteristics for the wellness and/or improvement scores may also be received in step 605. Exemplary wellness and/or improvement score characteristics include, but are not limited to, a type of medical questionnaire, or OMD, that was scored in order to determine the wellness and/or improvement score, a treatment associated with the wellness and/or improvement score, a diagnosis associated with the wellness and/or improvement score, and/or a characteristic of the patient for whom the wellness and/or improvement score was determined. Exemplary patient characteristics include, but are not limited to, comorbidities, demographic characteristics, concurrently received treatments, treatment compliance, patient vital signs, and measures of patient general health (e.g., weight, BMI, etc.). Exemplary treatment provider characteristics include, but are not limited to, gender, languages spoken, board certifications held, education credentials, specialties, years practicing medicine, and number of times he/she has performed a particular treatment.

In step 610, the received wellness and/or improvement score(s) and any additional information/characteristics (e.g., patent and/or treatment provider characteristics) may be associated with the received wellness and/or improvement scores and a ratings webpage (or series of webpages) that pertain to the treatment provider. The treatment provider may have his or her own webpage, or series of webpages, on an outcome rating website such as ratings website 164. In this way, received wellness and/or improvement scores may be associated with a treatment provider for a patient associated with the respective wellness and/or improvement scores.

In step 615, a request to view the wellness and/or improvement scores associated with the treatment provider may be received. In some embodiments, the request is received via a user, or potential patient/customer, selecting an icon such as icon 740, which will be discussed below via the discussion of FIG. 7A. The request may be a request to verify wellness and/or outcome scores provided by the treatment provider website via, for example, a third party offering a ratings website such as ratings website 164. In some cases, an indicator provided by a treatment provider's webpage via which a user/potential patient may access the ratings of the treatment provider may be associated with a URL or other metadata that facilitates receipt of the request in step 615. The indicator may be, for example, an icon, badge, image or other types of visual indicators.

In step 620, a ratings webpage for the treatment provider may be provided to a display device in communication with (e.g., viewed by) the requester of step 615. Exemplary ratings webpages are provided by the screen shots of interfaces shown in FIGS. 12A, 12B, 13A, 13B, and 13C, which are discussed below.

FIG. 7A provides a screen shot of a first interface 701 of an exemplary webpage provided by an online platform for display on a display device such as display 612 taken at a first moment in time t1 and FIG. 7B provides a screen shot of a second interface 702 of an exemplary webpage provided by an online platform for display on a display device such as display 612 taken at a second moment in time t2. The webpage is associated with the sender of the medical questionnaire that was provided in step 310, in this case Justin D. Saliman, MD an orthopedic surgeon and window 710 provides an image and some information about Dr. Saliman. First interface 701 also provides a first image of a ticker tape 715A that shows first, second, and third scrolling improvement score posts 720A, 720B, and 720C, respectively, as shown by the webpage at t1. Each of the score posts 720 include an indication of a number of wellness points the patient has gained over a particular time period. First improvement score post 720A provides information about a patient of Dr. Saliman's named Karen B. that includes Karen's improvement score, the type of assessment/medical questionnaire she answered (in this case the foot/ankle assessment), a duration of time over which Karen's condition has improved, and a graphic depiction of Karen's improvement over time in the form of a semi-circular graph. Second improvement score post 720B provides information about a patient of Dr. Saliman's named John H. that includes John's improvement score, the type of assessment/medical questionnaire she answered (in this case the knee assessment), a duration of time over which James' condition has improved, and a graphic depiction of James' improvement over time in the form of a semi-circular graph. Third improvement score post 720C provides information about a patient of Dr. Saliman's named James H. that includes John's improvement score, the type of assessment/medical questionnaire she answered (in this case the spine assessment), a duration of time over which James' condition has improved, and a graphic depiction of James' improvement over time in the form of a semi-circular graph.

First interface 701 also includes a graphic element, or icon, 740 that is linked to a ratings website like ratings website 164. Graphic element 740 may be a rich media object that includes, among other things, meta data and/or a URL that links to a ratings webpage offered by the ratings website. The ratings page may provide information to verify, or otherwise provide more detail for, one or more of the outcome-based measures displayed on interface 701.

Second interface 702 of FIG. 7B shows the same information in window 710 as first interface 701 but shows a second set of improvement score posts 715B at time t2 wherein the third post for James' spinal assessment 720C has moved across the ticker tape from the right side of the page as shown in first interface 701 to the left side of the second interface 702. First and second improvement scores 720A and 720B, respectively have been removed from the ticker tape display and been replaced by fourth and fifth improvement score posts 720D and 720E, respectively. At a time after t2, fifth and sixth improvement score posts 720D and 720E will move toward the left side of ticker tape 715B and third improvement score post 720C will be removed from ticker tape 715 and be replaced by a new improvement score post.

FIG. 8A provides a first interface 801 of another exemplary webpage provided by an online platform for display on a display device such as display 612 taken at a first moment in time t1 and FIG. 8B provides a second interface 802 of an exemplary webpage provided by an online platform for display on a display device such as display 612 taken at a second moment in time t2. The webpage is associated with the sender of the medical questionnaire that was provided in step 310, in this case Raymond B. Raven, MD a hand and upper limb specialist and window 810 provides an image and some information about Dr. Raven. First interface 801 also provides a first image of a ticker tape 815A that shows first, second, and third scrolling improvement score posts 820A, 820B, and 820C, respectively, as shown by the webpage at t1. First improvement score post 820A provides information about a patient of Dr. Raven's named Darek B. that includes Darek's improvement score, the type of assessment/medical questionnaire he answered (in this case a foot/ankle assessment), a duration of time over which Darek's condition has improved, and a graphic depiction of Darek's improvement over time in the form of a semi-circular graph. Second improvement score post 820B provides information about a patient of Dr. Raven's named Jonah H. that includes Jonah's improvement score, the type of assessment/medical questionnaire she answered (in this case the knee assessment), a duration of time over which Jonah's condition has improved, and a graphic depiction of Jonah's improvement over time in the form of a semi-circular graph. Third improvement score post 820C provides information about a patient of Dr. Raven's named Sanjay H. that includes Sanjay's improvement score, the type of assessment/medical questionnaire she answered (in this case the spine assessment), a duration of time over which Sanjay's condition has improved, and a graphic depiction of Sanjay's improvement over time in the form of a semi-circular graph.

Second interface 802 of FIG. 8B shows the same information in window 810 as first interface 801 but shows a second set of improvement score posts 815B at time t2 wherein the third post for Sanjay's spinal assessment 820C has moved across the ticker tape from the right side of the page as shown in first interface 801 to the left side of the second interface 802. First and second improvement scores 820A and 820B, respectively have been removed from the ticker tape display and been replaced by fourth and fifth improvement score posts 820D and 820E, respectively. At a time after t2, fifth and sixth improvement score posts 820D and 820E will move toward the left side of ticker tape 815B and third improvement score post 820C will be removed from ticker tape 815 and be replaced by a new improvement score post.

The improvement score posts for Dr. Saliman's and Dr. Raven's webpages will continue to scroll over time on a loop and will be updated, or augmented, over time as new improvement score posts are prepared via execution of, for example, any of the processes described herein.

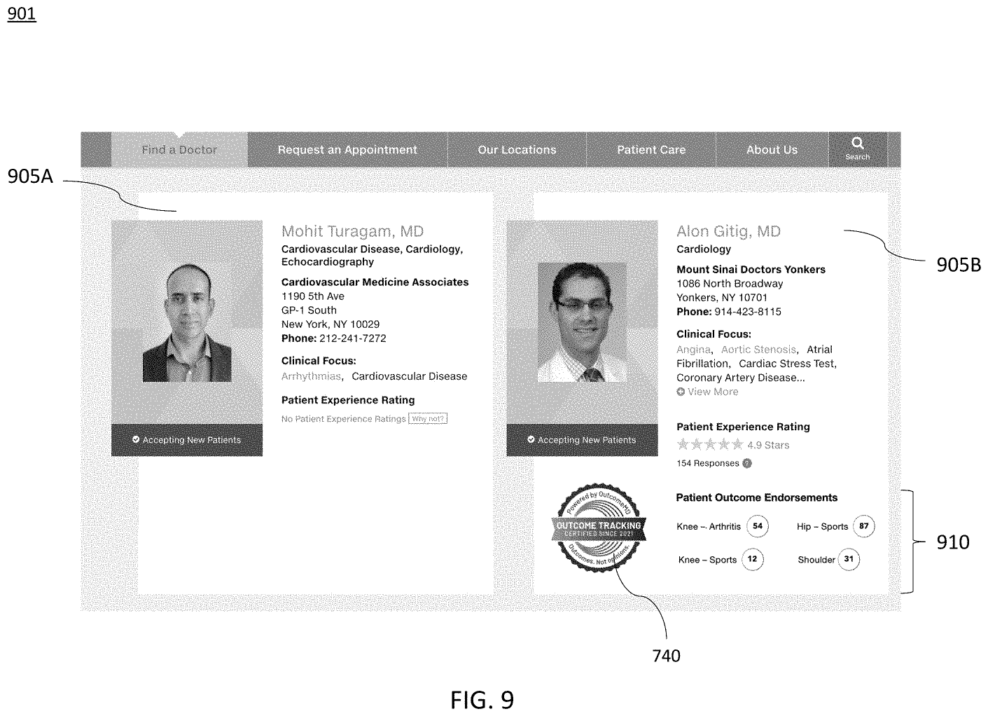

FIG. 9 is a diagram showing process 900 for communication between various components of a system, such as system 100, to facilitate provision of an outcome verification webpage to a requester. While the particular components of system 100 shown in FIG. 9 include patient device 128, server 102, ratings website 164, provider website 166, and provider device 168, it is contemplated that process 900 may be executed using more, or fewer, components.

Initially, a medical questionnaire, or OMD, is communicated by server 102 to patient device 128 (step 905) in a manner similar to, for example, execution of step 310. Then, answers to the medical questionnaire may be communicated from patient device 128 to server 102 (step 910) in a manner similar to, for example, execution of step 315. Server 102 may then score the received answers according to one or more processes described herein in order to determine a wellness and/or improvement score for the patient. The wellness and/or improvement score(s) may then be communicated from server 102 to patient device 128 (step 915), provider website 168 (step 920), and ratings website 164 (step 925).

In step 930, a request to view one or more pages of the provider website may be received (step 930). In some embodiments, execution of step 930 may occur via, for example, selection of a hyperlink associated with provider website 166 that may be included in, for example, a list of search results and/or provided by a treatment facility website. The treatment provider's website (which may include one or more wellness and/or improvement scores) may then be provided the provider device 168 by provider website 166 (step 935). Screen shots of exemplary provider website pages are shown in FIGS. 7A-7D, 8A, and 8B.

In step 940, a request to verify one or more wellness and/or improvement scores displayed on provider website 166 may be communicated from provider device 168 to provider website 166 via, for example, selection of a graphic element or icon like graphic element 740, which may initiate communication of the request to provider website 166 in step 940. The verification request may then be forwarded to ratings website by provider website 166 (step 945). Additionally, or alternatively, the verification request of step 940 may be communicated directly to ratings website 164 without being received by provider website 166 (step 940) and forwarded to rating website 164 (step 945).

Ratings website 164 may use information (e.g., metadata) included in, or otherwise associated with the request of step 940 and/or 945, to determine what wellness and/or improvement scores and/or treatment provider information the requester is trying to verify and may then provide the verification information to the provider device 168 (step 950) in the form of, for example, one or more ratings webpages, examples of which are provided by FIGS. 12A and 12B.

FIG. 9A is screen shots of a doctor information webpage interface 901 interface 901 includes a first doctor description window 905A that includes a description of a first doctor, in this case Mohit Turagam, and a second doctor description window 905B that includes a description of a second doctor, in this case Alon Gitig, that includes his description along with icon 740 and a listing of wellness scores 910.

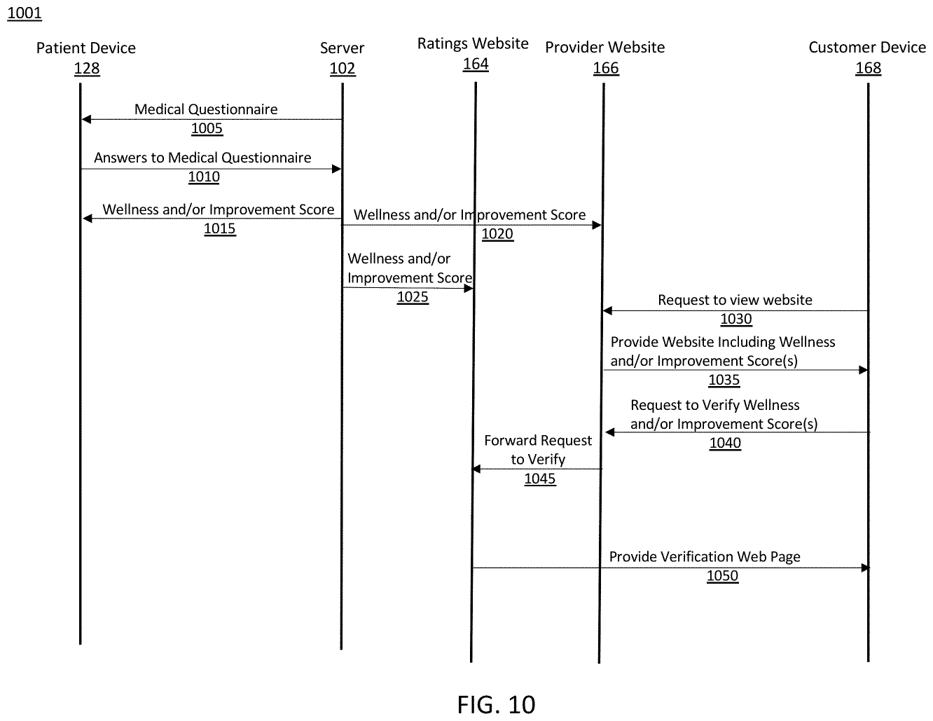

FIG. 10 is a diagram showing process 1000 for communication between various components of a system, such as system 100, to facilitate provision of an outcome verification webpage to a requester. While the particular components of system 100 shown in FIG. 10 include patient device 128, ratings website 164, provider website 166, and provider device 168, it is contemplated that process 1000 may be executed using more, or fewer, components.

Initially, a medical questionnaire, or OMD, is communicated by server 102 to patient device 128 (step 1005) in a manner similar to, for example, execution of step 310. Then, answers to the medical questionnaire, response data, may be communicated from patient device 128 to server 102 (step 1010) in a manner similar to, for example, execution of step 315. Server 102 may then score the received answers (response data) according to one or more processes described herein in order to prepare a post including a wellness and/or improvement score for the patient. The post may be generated as described herein (e.g., process 500 and/or 600) include metadata regarding the wellness and/or improvement score. The post may then be communicated to provider website 166 (step 1020) and ratings website 164 (step 1025) for publishing by server 102.

In step 1030, a request, initiated by provider device 168, to view one or more pages of the provider website may be received (step 1030) by the provider website 166. In some embodiments, execution of step 1030 may occur via, for example, selection of a hyperlink associated with provider website 166 that may be included in, for example, a list of search results and/or provided by a treatment facility website. The treatment provider's website (which may include one or more wellness and/or improvement scores) may then be provided to the provider device 168 by provider website 166 (step 1035). Screen shots of exemplary provider website pages are shown in FIGS. 7A-7D, 8A, and 8B.

In step 1040, a request to verify one or more wellness and/or improvement scores displayed on provider website 166 may be communicated from provider device 168 to provider website 166 via, for example, selection of a graphic element or icon like graphic element 740, which may initiate communication of the request to provider website 166 in step 1040. The verification request may then be forwarded to ratings website by provider website 166 (step 1045). Additionally, or alternatively, the verification request of step 1040 may be communicated directly to ratings website 164 without being received by provider website 166 (step 1040) and forwarded to rating website 164 (step 1045).

Ratings website 164 may use information (e.g., metadata) included in, or otherwise associated with the request of step 1040 and/or 1045, to determine what wellness and/or improvement scores and/or treatment provider information the requester is trying to verify and may then provide the verification information to the provider device 168 (step 1050) in the form of, for example, one or more ratings webpages, examples of which are provided by FIGS. 12A, 12B, 13A-13E, and 14A-14E.

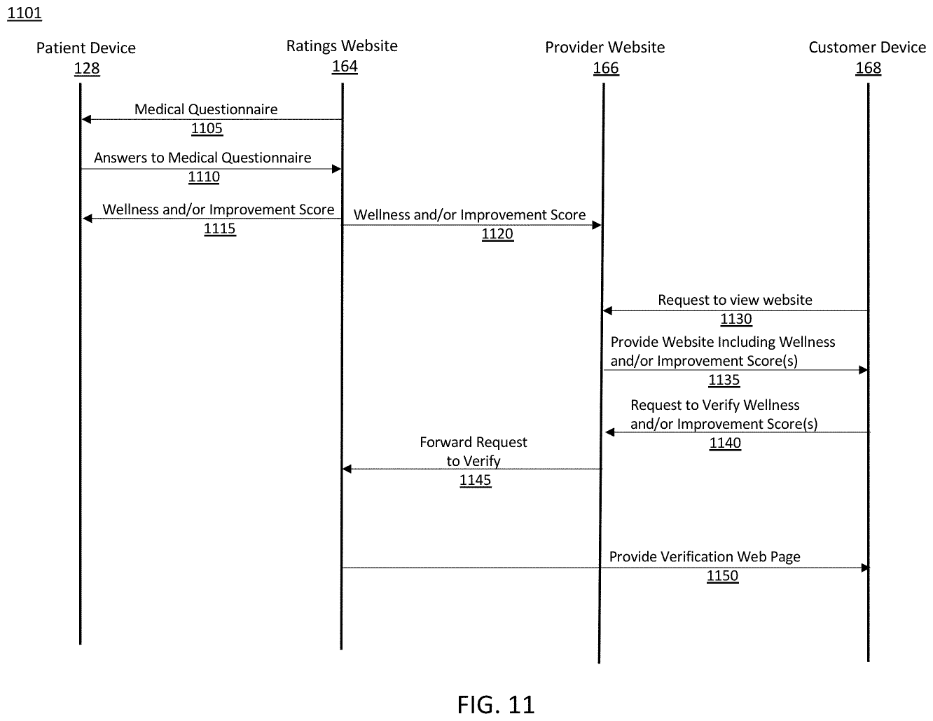

FIG. 11 is a diagram showing process 1100 for communication between various components of a system, such as system 100, to facilitate provision of an outcome verification webpage to a requester. While the particular components of system 110 shown in FIG. 11 include patient device 128, ratings website 164, provider website 166, and provider device 168, it is contemplated that process 1100 may be executed using more, or fewer, components.

Initially, a medical questionnaire, or OMD, is communicated by ratings website 164 to patient device 128 (step 1105) in a manner similar to, for example, execution of step 310. Then, answers to the medical questionnaire (response data) may be communicated from patient device 128 to ratings website 164 (step 1110) in a manner similar to, for example, execution of step 315. Ratings website 164 may then score the received answers according to one or more processes described herein in order to determine a wellness and/or improvement score for the patient. The wellness and/or improvement score may then be communicated to provider website 166 (step 1020).

In step 1130, a request to view one or more pages of the provider website may be received (step 1130). In some embodiments, execution of step 1130 may occur via, for example, selection of a hyperlink associated with provider website 166 that may be included in, for example, a list of search results and/or provided by a treatment facility website. The treatment provider's website (which may include one or more wellness and/or improvement scores) may then be provided the provider device 168 by provider website 166 (step 1135). Screen shots of exemplary provider website pages are shown in FIGS. 7A-7D, 8A, and 8B.

In step 1140, a request to verify one or more wellness and/or improvement scores displayed on provider website 166 may be communicated from provider device 168 to provider website 166 via, for example, selection of a graphic element or icon like graphic element 740, which may initiate communication of the request to provider website 166 in step 1140. The verification request may then be forwarded to ratings website by provider website 166 (step 1145). Additionally, or alternatively, the verification request of step 1140 may be communicated directly to ratings website 164 without being received by provider website 166 (step 1140) and forwarded to rating website 164 (step 1145).

Ratings website 164 may use information (e.g., metadata) included in, or otherwise associated with the request of step 1140 and/or 1145, to determine what wellness and/or improvement scores and/or treatment provider information the requester is trying to verify and may then provide the verification information to the provider device 168 (step 1150) in the form of, for example, one or more ratings webpages, examples of which are provided by FIGS. 12A, 12B, 13A-13E, and 14A-14E.

FIGS. 12A and 12B provide screen shots of a first and a second exemplary rating web page and/or interface 1201 and 1202, respectively, that show outcome-based ratings for a treatment provider in the form of providing wellness and/or improvement scores associated with the treatment provider and various treatments the provider has administered to patients. The rating webpage interfaces of FIGS. 12A and 12B provide a header 1210 that includes information about the treatment provider and may also include an optional icon, or graphic element 1215, by which to schedule an appointment with the treatment provider. Interface 1201 also includes a list of types of wellness and/or improvement scores 1220, which may be affiliated with a particular OMD or questionnaire and/or treatment provided by the treatment provider. In the example of interface 1201, list 1220 indicates that the treatment provider has 54 hip-arthritis wellness/improvement scores a viewer/user/customer/potential patient may access, 29 hip-sports wellness/improvement scores the viewer/user/customer/potential patient may access, and 28 knee-arthritis wellness/improvement scores the viewer/user/customer/potential patient may access. Additional information about each of these wellness/improvement scores may be accessed by selecting the corresponding “view all” icon 1225. Second interface 1202 provides an example of a drop-down list 1230 of a set (in this case, 14) of wellness/improvement scores for a knee-sports assessment for patients associated with the treatment provider. Drop-down list 1230 provides a set of graphs 1235 that show the initial wellness scores, improvement range, a subsequently determined wellness score, and an improvement percentage of 14 of the treatment provider's patients who have received treatment for a knee-sports type injury/diagnosis and/or are affiliated with an OMD designed to assess improvement in for knee-sports type injury/diagnosis. Graphs 1235 also provide basic information about the patient for which a particular graph pertains. In the embodiment of FIG. 12B, the basic patient information provided is the gender and age of each patient for whom a graph 1235 is provided.

FIGS. 13A-13B provide screen shots of a second set of exemplary ratings interfaces that show outcome-based ratings for a treatment provider in the form of providing wellness and/or improvement scores associated with the treatment provider and various treatments the provider has administered to patients. The rating webpage interfaces of FIGS. 13A and 13B provide a header 1310 that includes information about the treatment provider and may also include an optional way for the viewer to access addition information, in this case a brief video presentation regarding how the ratings website works and the information it provides. Interface 1301 also includes a list of types of wellness and/or improvement scores 1320, which may be affiliated with a particular OMD or questionnaire and/or treatment provided by the treatment provider. In the example of interface 1301, list 1320 indicates that the treatment provider has 643 shoulder wellness and/or improvement scores a viewer/user/customer/potential patient may access, 643 hip-arthritic wellness/improvement scores the viewer/user/customer/potential patient may access, 643 knee-sports wellness/improvement scores the viewer/user/customer/potential patient may access, and 643 complex regional pain syndrome wellness/improvement scores the viewer/user/customer/potential patient may access. Additional information about each of these wellness/improvement scores may be accessed by selecting the corresponding “>” icon 1335. Interface 1301 also includes a window 1330 in which a brief video (e.g., a .gif file) may animate a set of wellness and improvement scores on a graph 1325. Further information regarding this animation is provided below with regard to the discussion of FIGS. 13C-13E. Window 1330 also provides a hyperlink to the treatment provider's website.

Second interface 1202 provides an example of a drop-down list 1340 of a set (in this case, 4) of wellness/improvement scores for a shoulder assessment for patients associated with the treatment provider. Drop-down list 1340 provides a set of graphs that show the initial wellness scores, improvement range, a subsequently determined wellness score, and an improvement percentage for of 14 of the treatment provider's patients who have received treatment for a shoulder type injury/diagnosis and/or are affiliated with an OMD designed to assess improvement in for shoulder type injury/diagnosis. The graphs of drop-down list 1340 also provide basic information about the patient for which a particular graph pertains. In the embodiment of FIG. 13B, the basic patient information provided is the gender and age of each patient for whom a graph 1235 is provided.

FIGS. 13C-13E provide a time series of images of the animated graph of window 1330 in which a first graph 1303 of FIG. 13C shows an initial, or baseline, wellness score 1345 and a graphic representation of the initial wellness score 1340 (i.e., from a wellness score of 0 to the initial wellness score value); a second graph 1304 of FIG. 13D shows improvement potential 1350, which is the difference between the initial, or baseline, wellness score and the maximum achievable wellness score, and a third graph 1305 of FIG. 13E shows a second wellness score 1360 as well as a degree of improvement achieved 1355, which is the difference between the initial and second wellness scores overlaid upon the graphic representation of improvement potential 1350.

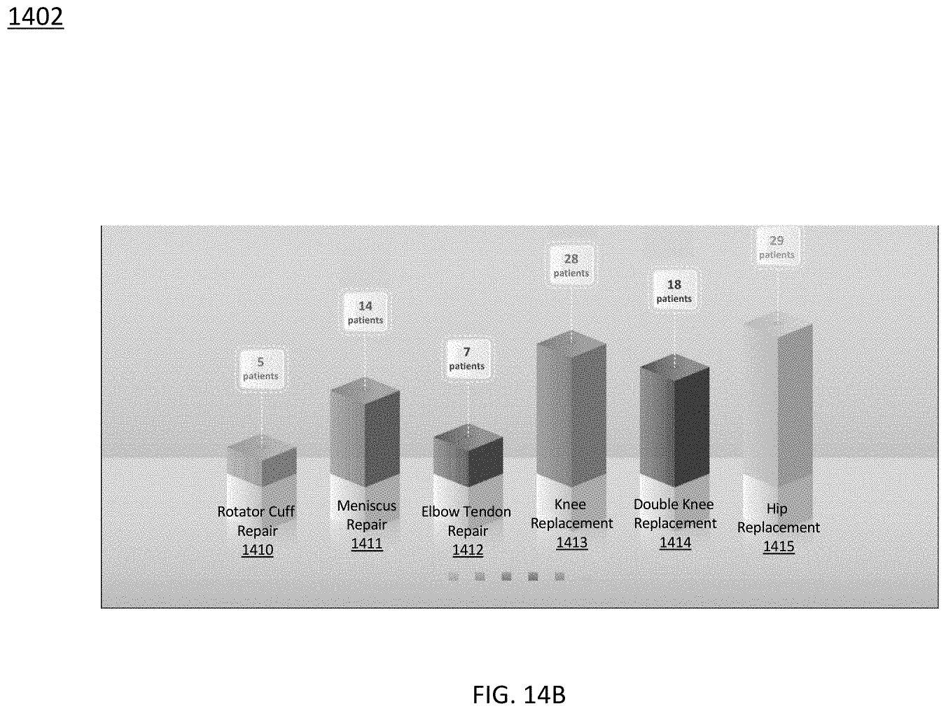

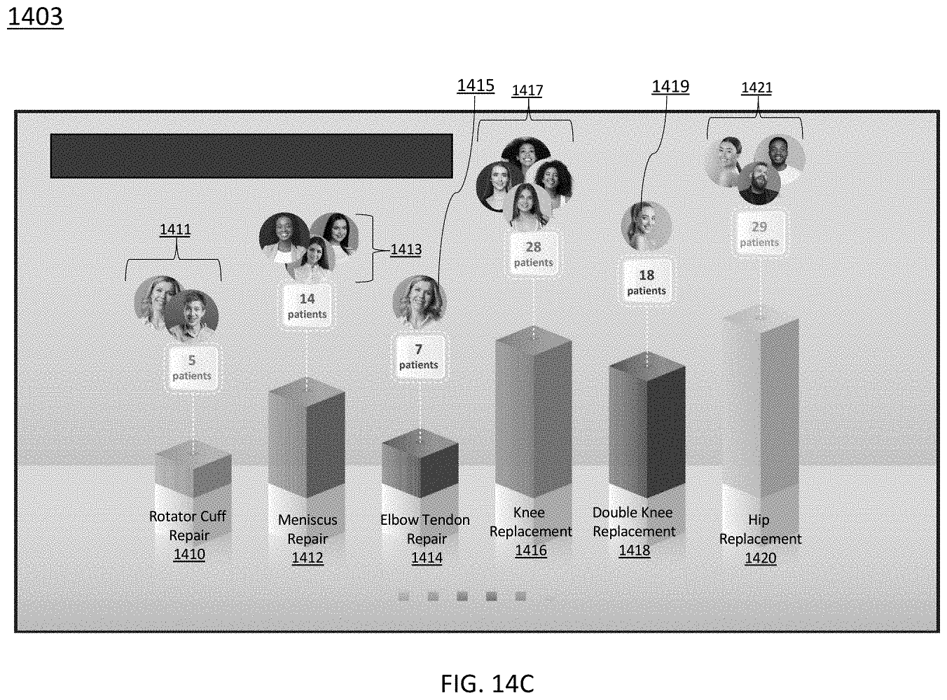

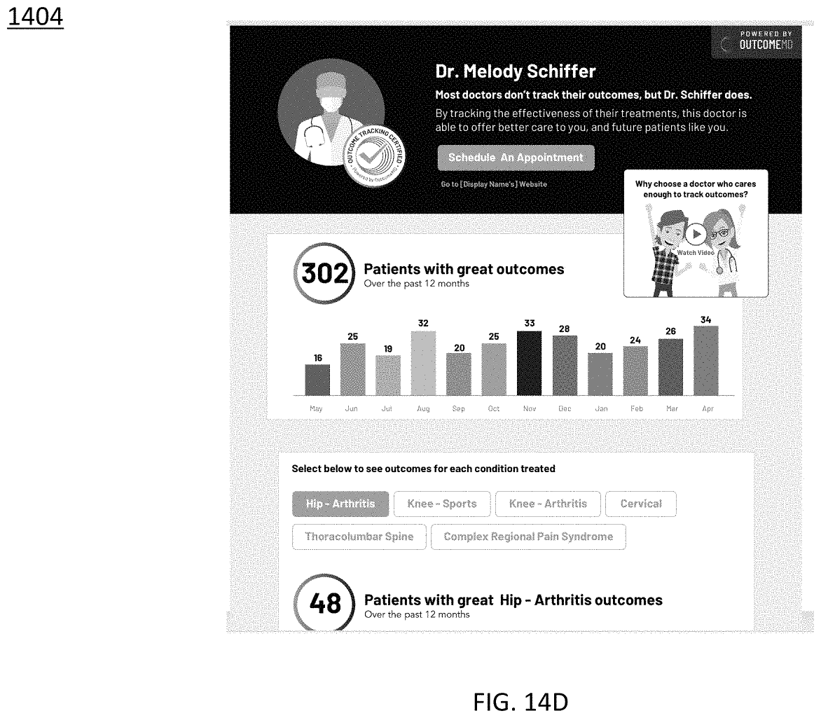

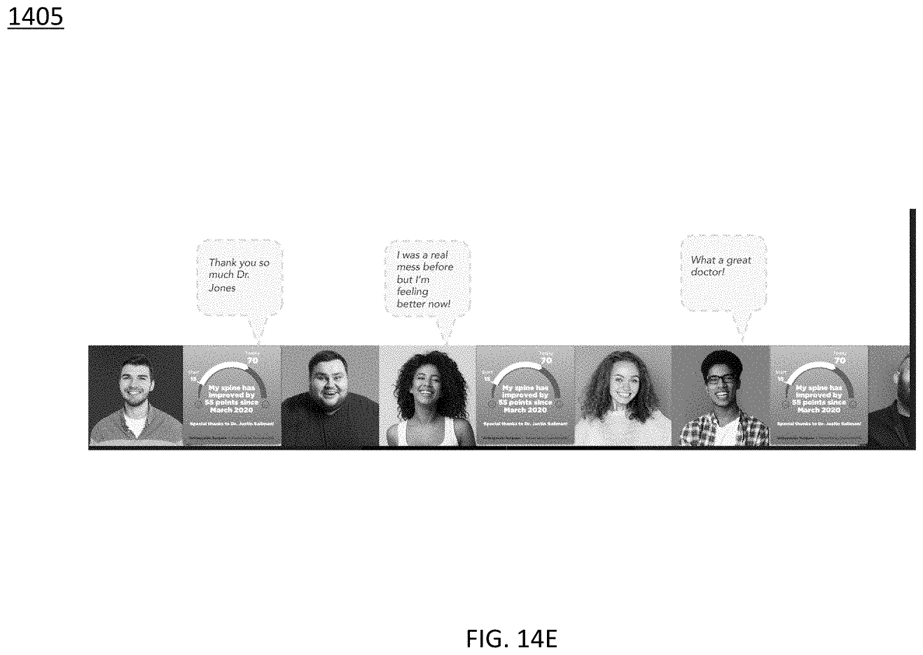

FIG. 14A provides a time series of interfaces 1401A, 1401B, and 1401C into which a patient may enter a comment, add a photo, and/or post a review regarding a treatment the patient has received and/or participated in. First interface 1401A (shown on the left of FIG. 0.14C) may be displayed to the patient and may provide the patient with an opportunity to provide a rating, comment, and/or additional information regarding, for example, the treatment and/or his or her general wellbeing when, for example, he or she has completed a medical questionnaire, received a wellness score, and/or an improvement score. First interface 1401A provides a text box 1420 into which the patient may enter (e.g., type or add an image or emoji), an add a photo icon 1425, the selection of which enables the patient to upload a photo, and an accept terms and post review icon 1425 by which the patient may accept one or more terms of use and publish and/or post his or her comments, photo, and/or review. Second interface 1401B shows a photograph 1435 of the patient uploaded to the interface via add photo icon 1425 (which has changed to a change photo icon 1427 responsively to the patient uploading a photo) and also includes a comment regarding the medical care received from, in this case, Dr. Brown that has been typed into text box 1420. Third interface 1401C displays a message indicating that the patient has an opportunity to post his or her comment, rating, and/or photo to a social media platform (in this case, FACEBOOK or TWITTER) and/or a ratings website (in this case YELP or GOOGLE) via, for example, selection of one or more icons from an icon array 1435 provided by the interface.

FIG. 14B provides a screen shot of an exemplary bar graph ratings interface 1402 wherein a number of patients who have completed medical questionnaires pertaining to a particular characteristic and/or category (e.g., treatment, diagnosis, patient characteristic, etc.) are counted and shown in graphic form. In the embodiment of FIG. 14A, there are six categories pertaining to an orthopedic surgeon with a first graph 1410 showing a number of patients (5) he has treated with a rotator cuff repair treatment, a second graph 1412 showing a number of patients (14) he has treated with a meniscus repair treatment, a third graph 1414 showing a number of patients (7) he has treated with an elbow repair treatment, a fourth graph 1416 showing a number of patients (28) he has treated with a knee replacement treatment, a fifth graph 1418 showing a number of patients (18) he has treated with a double knee replacement treatment, and a sixth graph 1420 showing a number of patients (29) he has treated with a hip replacement treatment. In this way, a user and/or perspective patient may easily view and compare how much experience (i.e., the number of patients) a particular physician has with performing particular types of treatments that may (as the case is here) or may not be related to one another. As depicted in FIG. 14A, the number of patients associated with each respective treatment category is shown in both bar graph form and as a numerical value in a graphic element above each respective bar of the bar graph (where each bar graph and associated number of patients are shown in a different color) for ease of comprehension and comparison.

FIG. 14C provides a second bar graph ratings interface 1403 that includes the same bar graph as FIG. 14B except that the second bar graph ratings interface 1403 also includes pictures of some of the patient for whom wellness and/or improvement scores that have been determined for data contributing to the bar graph. The photographs may be received from the patient via, for example, an interface like the interfaces of FIG. 14A. In particular, first graph 1410 is associated with a first group 1411 of photographs of two patients the treatment provider has treated with a rotator cuff repair treatment, second graph 1412 is associated with a second group 1413 of photographs of three patients the treatment provider has treated with the meniscus repair treatment, third graph 1414 is associated with a third group 1415 of a photograph of one patient the treatment provider has treated with an elbow tendon repair treatment, fourth graph 1416 is associated with a fourth group 1417 of photographs of four patients the treatment provider has treated with a knee replacement treatment, fifth graph 1418 is associated with a fifth group 1419 of photographs of one patient the treatment provider has treated with a double knee replacement treatment, and sixth graph 1420 is associated with a sixth group 1421 of photographs of three patients the treatment provider has treated with a hip replacement treatment.

FIG. 14D provides another exemplary ratings interface 1404 that shows a bar graph of a number of patients (302 in total) a medical treatment provider (in this case, Dr. Melody Schiffer) over time (in this case, 12 months) in monthly increments. Ratings interface 1402 also shows a count of patients above each line in the bar graph.

FIG. 14E provides a screen shot of a ticker tape 1405 that is similar to ticker tape 715 except that it also includes photographs/images of patients associated with particular wellness and/or improvement scores and also shows comments made by patients. Ticker 1405 may be included in, for example, a treatment provider webpage in a manner similar ticker tape 715 of interfaces 7A-7D, 8A, and 8B.

The preceding description has shown effectively how to publish wellness and improvement information on provider websites. The wellness and improvement information may be in the form of a score which over time accumulates to series of scores that can be shown in a display available to viewers for ease of comparison of effectiveness of medical treatments. Evaluations of providers and provider treatments is made objectively unlike prior art methods. Additionally, or alternatively, wellness and/or improvement scores may be provided on ratings websites for viewing by the general publish allowing potential patients for objective assessment among medical professionals.

We claim:

1. A method comprising:
in response to receiving response data responsive to a medical questionnaire from a patient device associated with a patient, preparing a post including a wellness and/or improvement score associated with the response data of the medical questionnaire from the patient device;
storing the post in a persistent data store;
receiving user preference data representative of preference of a user of a client device;
in response to receiving user preference data, transmitting the post from the persistent data store to a provider website for publication.

2. The method of claim 1, further comprising:
generating the wellness and/or improvement score by a server in communication with the patient device, the provider website, and the ratings website.

3. The method of claim 1, further comprising:
receiving a plurality of wellness and/or improvement scores;
preparing a series of posts, each post of the series including one of the plurality of wellness and/or improvement scores;
communicating the series of posts to the provider website for publication.

4. The method of claim 1, wherein a request to view one or more webpages of the provider website includes selection of a hyperlink associated with the provider website included in a list of search results and/or provided by a treatment facility website.

5. The method of claim 4, wherein metadata associated with the request is used to determine one of a selection of wellness and/or improvement scores including the wellness and/or improvement score to generate verification information used by the provider device for displaying one of the selection of wellness and/or improvement scores on the ratings webpage.

6. The method of claim 1, the method further comprising:
displaying the wellness and/or improvement score on the provider website; and
receiving a verification request, originating from a provider device, to verify the wellness and/or improvement score on the provider website through a selection of a graphic element or icon.

7. The method of claim 6, further comprising:
the verification request is communicated directly to the ratings website.

8. The method of claim 6, wherein the post including the wellness and/or improvement score is published based on a threshold reflecting one or more user preferences of a customer of the provider device.

9. The method of claim 6, wherein the post including the wellness and/or improvement score is published based on a threshold reflecting user preferences of a provider of the provider website.

10. The method of claim 1, wherein an indicator is displayed by a webpage of the provider website for use by a viewer of the provider website to access ratings of a treatment provider.

11. The method of claim 10, wherein different wellness and/or improvement scores are displayed on an interface of a webpage of the provider website using a ticker tape.

12. The method of claim 10, wherein different wellness and/or improvement scores are displayed on an interface of a webpage of the provider website using a ticker tape that includes a graphical representation of a set of wellness and/or improvement scores, including the wellness and/or improvement scores of the post over time.

13. The method of claim 12, wherein the graphical representation is in the form of a semicircle graph or a bar graph.

14. The method of claim 11, wherein the ticker tape is one of a plurality of ticker tapes, each ticker tape associated with a plurality of wellness and/or improvement scores of a similar treatment performed on users of respective patient devices.

15. The method of claim 11, wherein the ticker tape is one of a plurality of ticker tapes associated with a plurality of wellness and/or improvement scores of different treatments performed on users of respective patient devices.

16. A system for publishing scores on one or more websites, comprising:
one or more electronic processors configured to execute a set of computer-executable instructions;
one or more non-transitory electronic data storage media containing the set of computer-executable instructions, wherein when executed, the instructions cause the one or more electronic processors to:
in response to receiving response data responsive to a medical questionnaire from a patient device associated with a patient, preparing a post including a wellness and/or improvement score associated with the response data of the medical questionnaire from the patient device;
storing the post in a persistent data store;
receiving user preference data representative of preference of a user of a client device;
in response to receiving user preference data, transmitting the post from the persistent data store to a provider website for publication; and
in response to receiving user preference data, transmitting the post from the persistent data store to a ratings website for publication.

17. The system of claim 16, wherein the instructions cause the one or more electronic processors to:
generate the wellness and/or improvement score by a server in communication with the provider website, the ratings website, and the patient device.

18. The system of claim 16, wherein the instructions cause the one or more electronic processors to:
generate the wellness and/or improvement score by the ratings website.

19. The system of claim 16, wherein the instructions cause the one or more electronic processors to:
receive a request to view one or more webpages of the provider website, wherein the request includes selection of a hyperlink associated with the provider website included in a list of search results and/or provided by a treatment facility website.

20. The system of claim 19, wherein metadata associated with the request is used to determine one of a selection of wellness and/or improvement scores including the wellness and/or improvement score to generate verification information used by the provider device for displaying the one of the selection of wellness and/or improvement scores on the ratings webpage.
